(19) United States
(12) Patent Application Publication
(10) Pub. No.: US 2015/0050556 A1
(43) Pub. Date: Feb. 19, 2015

(54) ETCHED SILICON STRUCTURES, METHOD OF FORMING ETCHED SILICON STRUCTURES AND USES THEREOF

(71) Applicant: Nexeon Ltd., Abingdon (GB)

(72) Inventors: Fengming Liu, Reading (GB); Yuxiong Jiang, Abingdon (GB); Christopher Michael Friend, Abingdon (GB); Jonathon Speed, Reading (GB)

(73) Assignee: Nexeon Ltd., Abingdon (GB)

(21) Appl. No.: 14/387,284

(22) PCT Filed: Mar. 21, 2013
(86) PCT No.: PCT/GB2013/050742

§ 371 Date: Sep. 23, 2014

(30) Foreign Application Priority Data
Mar. 23, 2012 (GB) 1205178.5

(51) Int. Cl. H01M 4/38; H01M 4/04; C01B 33/02; H01M 4/1395

(52) U.S. Cl. CPC H01M 4/386; H01M 4/1395; H01M 4/0492; H01M 4/0402; C01B 33/02; H01M 10/0525
USPC 429/218.1; 216/13; 423/348; 428/156

(57) ABSTRACT

A method of etching silicon of a material comprising silicon, the method comprising the steps of partially covering a silicon surface of the material comprising silicon with an elemental metal and then carrying out a metal-assisted chemical etching of the silicon by exposing the partially covered silicon surface to an etching composition, wherein at least some of the elemental metal for the metal-assisted chemical etching is formed by either: (a) exposing the silicon surface to a composition comprising metal ions, wherein the elemental metal forms by reduction of the metal ions and wherein the composition comprising metal ions is substantially free of HF, or (b) depositing the elemental metal directly onto the silicon surface.

### FIELD OF THE INVENTION

The present invention relates to methods of etching silicon, etched silicon structures, electrodes containing etched silicon structures and devices including etched silicon structures.

### BACKGROUND OF THE INVENTION

Etched silicon structures comprising pores or elongated pillar-like structures may be used in a wide range of applications including electrochemical cells, metal ion batteries such as lithium-ion batteries, lithium air batteries, flow cell batteries, other energy storage devices such as fuel cells, thermal batteries, photovoltaic devices such as solar cells, filters, sensors, electrical and thermal capacitors, microfluidic devices, gas/vapour sensors, thermal or dielectric insulating devices, devices for controlling or modifying the transmission, absorption or reflectance of light or other forms of electromagnetic radiation, chromatography or wound dressings.

Porous silicon particles may also be used for the storage, controlled delivery or timed release of ingredients or active agents in consumer care products including oral hygiene and cosmetic products, food or other nutritional products, or medical products including pharmaceutical products that deliver drugs internally or externally to humans or animals.

Etched silicon may also form architectured conducting or semiconducting components of electronic circuitry.

The structure of a conventional lithium-ion rechargeable battery cell is shown in FIG. 1. The battery cell includes a single cell but may also include more than one cell. Batteries of other metal ions are also known, for example sodium ion and magnesium ion batteries, and have essentially the same cell structure.

The battery cell comprises a current collector for the anode 10, for example copper, and a current collector for the cathode 12, for example aluminium, which are both externally connectable to a load or to a recharging source as appropriate. A composite anode layer 14 overlays the current collector 10 and a lithium containing metal oxide-based composite cathode layer 16 overlays the current collector 12 (for the avoidance of any doubt, the terms “anode” and “cathode” as used herein are used in the sense that the battery is placed across a load—in this sense the negative electrode is referred to as the anode and the positive electrode is referred to as the cathode).

The cathode comprises a material capable of releasing and reabsorbing lithium ions for example a lithium-based metal oxide or phosphate, LiCoO₂, LiNi_{0.8}Co_{0.15}Al_{0.05}O₂, LiMnₓNiₓCo₁₋₂ₓO₂ or LiFePO₄.

A porous plastic spacer or separator 20 is provided between the graphite-based composite anode layer 14 and the lithium containing metal oxide-based composite cathode layer 16. A liquid electrolyte material is dispersed within the porous plastic spacer or separator 20, the composite anode layer 14 and the composite cathode layer 16. In some cases, the porous plastic spacer or separator 20 may be replaced by a polymer electrolyte material and in such cases the polymer electrolyte material is present within both the composite anode layer 14 and the composite cathode layer 16. The polymer electrolyte material can be a solid polymer electrolyte or a gel-type polymer electrolyte and can incorporate a separator.

When the battery cell is fully charged, lithium has been transported from the lithium containing metal oxide cathode layer 16 via the electrolyte into the anode layer 14. In the case of a graphite-based anode layer, the lithium reacts with the graphite to create the compound, LiC₆. The graphite, being the electrochemically active material in the composite anode layer, has a maximum capacity of 372 mAh/g. (“active material” or “electroactive material” as used herein means a material which is able to insert into its structure, and release therefrom, metal ions such as lithium, sodium, potassium, calcium or magnesium during the respective charging phase and discharging phase of a battery. Preferably the material is able to insert and release lithium.)

The use of silicon as the anode for a metal ion battery, for example a lithium ion battery, is known. Silicon has a substantially higher maximum capacity than graphite. However, unlike active graphite which remains substantially unchanged during insertion and release of metal ions, the process of insertion of metal ions into silicon results in substantial structural changes, accompanied by substantial expansion. For example, insertion of lithium ions into silicon results in formation of a Si—Li alloy. The effect of Li ion insertion on the anode material is described in, for example, “Insertion Electrode Materials for Rechargeable Lithium Batteries”, Winter et al, Adv. Mater. 1988, 10, No. 10, pages 725-763.

U.S. Pat. No. 7,402,829 discloses etching of a silicon substrate to form an array of silicon pillars extending from the silicon substrate for use in lithium ion batteries by electroless deposition of silver. WO2009/010758 discloses the etching of silicon powder in order to make silicon material for use in lithium ion batteries. The resulting etched particles contain pillars on their surface. These structured silicon electrodes show good capacity retention when subjected to repeated charge/discharge cycles and this good capacity retention is believed to be due to the ability of the silicon pillars to absorb the volumetric expansion/contraction associated with lithium insertion/extraction from the host silicon without the pillars being broken up or destroyed.

Silicon may be etched as described in WO 2007/083152, wherein silver is deposited on the silicon surface by a process of electroless deposition followed by etching of silicon underlying the deposited silver. In electroless deposition, the silicon is exposed to a solution of a metal salt, for example silver nitrate, and a source of fluoride ions, for example HF. The fluoride ions react with the silicon to generate electrons (Equation 1) that cause reduction of the silver ions of the silver salt (Equation 2):

Si⁰+6F⁻→SiF₆²⁻+4e⁻ (Equation 1)

Ag⁺(aq)+e⁻→Ag(s) (Equation 2)

Geng et al, “Metal-Assisted Chemical Etching Using Tollen's Reagent to Deposit Silver Nanoparticle Catalysts for Fabrication of Quasi-ordered Silicon Micro/Nanostructures”, Journal of Electronic Materials, Vol. 40, No. 12, 2011 discloses deposition of nanoscale silver particles on (100) and (111) surfaces of polished p-Si wafers through the silver mirror reaction followed by etching in 1:1:1 (v:v:v) HF(49%):H₂0₂(30%):EtOH solution.

It is an object of the invention to provide an improved process for etching silicon, including bulk silicon and silicon powder, and in particular a process for providing improved control over etching of silicon.

### SUMMARY OF THE INVENTION

In a first aspect, the invention provides a method of etching silicon of a material comprising silicon, the method comprising the steps of partially covering a silicon surface of the material comprising silicon with an elemental metal and then carrying out a metal-assisted chemical etching of the silicon by exposing the partially covered silicon surface to an etching composition, wherein at least some of the elemental metal for the metal-assisted chemical etching is formed by either:
(a) exposing the silicon surface to a composition comprising metal ions, wherein the elemental metal is formed by reduction of the metal ions and wherein the composition comprising metal ions is substantially free of HF; or
(b) depositing the elemental metal directly onto the silicon surface.

Optionally, the composition comprising metal ions comprises a reducing agent.

Optionally, the composition comprising metal ions further comprises an aldehyde reducing agent and an alkali.

Optionally, the alkali is a metal hydroxide or metal carbonate.

Optionally, the elemental metal is deposited directly onto the silicon surface through a patterned mask.

Optionally, the metal formed on the surface of the silicon is selected from silver, copper, platinum and gold.

Optionally, the etching composition is an aqueous etching composition comprising fluoride ions and an oxidant.

Optionally, the fluoride ions in the aqueous etching composition are provided by hydrogen fluoride.

Optionally, the oxidant is selected from the group consisting of O₂; O₃; hydrogen peroxide; and the acid or salt of NO₃⁻, S₂O₈²⁻, NO₂⁻, B₄O₇²⁻ or ClO₄⁻ or a mixture thereof.

Optionally, the oxidant is selected from the group consisting of alkali metal nitrates, ammonium nitrate and mixtures thereof.

Optionally, the surface of the silicon is etched to a depth of at least 0.25 microns.

Optionally, the etched silicon comprises pores extending into the etched silicon surface.

Optionally, the pores have a diameter of at least 10 nm.

Optionally, the etched silicon comprises pillars extending out from an etched surface formed by etching the silicon surface.

Optionally, the pillars have a length of at least 0.5 microns.

Optionally, the silicon to be etched is n-doped, p-doped or a mixture thereof.

Optionally, the silicon to be etched is in the form of bulk silicon, optionally a silicon wafer.

Optionally, the silicon to be etched is in the form of a silicon powder.

Optionally, at least 50% of the total volume of the powder is made up of starting material particles having a particle size of no more than 25 microns.

Optionally, the powder has a surface area per unit weight of more than 1 m²/g

Optionally, the silicon to be etched comprises multiple faces and wherein the surface of more than one face is etched.

Optionally, the material comprising silicon consists essentially of silicon having a purity of at least 90%.

Optionally, the material comprising silicon comprises a non-silicon core and a silicon shell.

Optionally, at least some of the elemental metal for the metal-assisted chemical etching is formed by exposing the silicon surface to the composition comprising metal ions, wherein the composition comprising metal ions is substantially free of fluoride ions.

Optionally, the step of partially covering a silicon surface of the material comprising silicon with an elemental metal comprises exposing the material comprising silicon to a plurality of compositions comprising metal ions, wherein the elemental metal forms on the silicon surface by reduction of the metal ions from each composition. Optionally, at least one of the compositions comprising metal ions further comprises fluoride ions, optionally HF.

Optionally, substantially all of the elemental metal for the metal-assisted chemical etching is formed by either (a) or (b) as described above.

Optionally, the metal ions are metal complex ions.

Optionally, the material comprising silicon is silicon having a purity of at least 99.8 weight %, optionally at least 99.85 weight %.

Optionally, the material comprising silicon contains less than 0.03 weight % iron, optionally less than 0.02 weight % iron.

Optionally, the material comprising silicon contains less than 0.08 weight %, aluminium, optionally less than 0.05 weight %, or less than 0.02 weight % aluminium.

In a second aspect the invention provides etched silicon obtainable by a method according the first aspect.

In a third aspect the invention provides an electrode comprising an active material of etched silicon according to the second aspect.

Optionally according to the third aspect, the electrode further comprises a conductive current collector in electrical contact with the active material.

In a fourth aspect the invention provides a method of forming an electrode according to the third aspect, the method comprising the step of depositing onto the conductive current collector a slurry comprising an etched silicon powder according to the second aspect and at least one solvent, and evaporating the at least one solvent.

In a fifth aspect the invention provides a rechargeable metal ion battery comprising an anode, the anode comprising an electrode according to the third aspect capable of inserting and releasing metal ions; a cathode formed from a metal-containing compound capable of releasing and reabsorbing the metal ions; and an electrolyte between the anode and the cathode.

Optionally according to the fifth aspect, the metal ion battery is a lithium ion battery.

In a sixth aspect the invention provides a method of etching silicon of a material comprising silicon, the method comprising the steps of:
electrolessly depositing a first metal onto silicon at a surface of the material comprising silicon, wherein the electrolessly deposited first metal partially covers the silicon surface and wherein the first metal is deposited from a composition comprising ions of the metal, the composition being substantially free of HF, optionally substantially free of fluoride ions;
depositing a second metal over the silicon surface and the electrolessly deposited first metal, wherein a film of the deposited second metal covers substantially all of the silicon surface;
removing the first metal, and the second metal from regions of the film of the deposited second metal that overlie the first metal to leave the second metal partially covering the surface of the silicon to be etched; and
etching the silicon by exposing the silicon surface to an etching composition.

The method of the sixth aspect may be carried out with any of the materials or compositions described with reference to the first aspect. Etched silicon produced by the sixth aspect may be used to form an electrode, for example an electrode of a metal ion battery, as described with reference to the fourth and fifth aspects of the invention.

In a seventh aspect the invention provides a method of etching silicon of a material comprising silicon, the method comprising the steps of partially covering a silicon surface of the material comprising silicon with an elemental metal and then carrying out a metal-assisted chemical etching of the silicon by exposing the partially covered silicon surface to an etching composition, wherein at least some of the elemental metal for the metal-assisted chemical etching is formed by exposing the silicon surface to a composition comprising metal ions, wherein the elemental metal forms by reduction of the metal ions and wherein the composition comprising metal ions comprises an aldehyde reducing agent and an alkali.

In an eighth aspect the invention provides a method of etching silicon of a material comprising silicon, the method comprising the steps of partially covering a silicon surface of the material comprising silicon with an elemental metal and then carrying out a metal-assisted chemical etching of the silicon by exposing the partially covered silicon surface to an etching composition, wherein at least some of the elemental metal for the metal-assisted chemical etching is formed by exposing the silicon surface to a composition comprising metal ions, wherein the elemental metal forms by reduction of the metal ions and wherein the composition comprising metal ions comprises a metal citrate, a metal borohydride, a hydrazine or a metal hypophosphite.

In a ninth aspect the invention provides a method of etching silicon of a material comprising silicon, the method comprising the steps of partially covering a silicon surface of the material comprising silicon with an elemental metal and then carrying out a metal-assisted chemical etching of the silicon by exposing the partially covered silicon surface to an etching composition, wherein at least some of the elemental metal for the metal-assisted chemical etching is formed by exposing the silicon surface to a composition comprising metal ions, wherein the elemental metal forms by reduction of the metal ions and wherein the composition comprising metal ions comprises an alcohol and a metal hydroxide.

Optionally according to the ninth aspect, the metal hydroxide is an alkali hydroxide.

In a tenth aspect the invention provides a method of etching silicon of a material comprising silicon, the method comprising the steps of partially covering a silicon surface of the material comprising silicon with elemental metal and then carrying out a metal-assisted chemical etching of the silicon by exposing the partially covered silicon surface to an etching composition, wherein the elemental metal is formed by exposing the silicon surface to a first composition comprising metal ions to form a first portion of the elemental metal on the silicon surface by reduction of the metal ions of the first composition; removing the material from the first composition; and exposing the silicon surface to a second composition comprising metal ions to form a second portion of the elemental metal on the silicon surface by reduction of the metal ions of the second composition, wherein the second composition is different from the first composition.

Optionally according to the tenth aspect, at least one of the first and second compositions comprises a reducing agent.

Optionally according to the tenth aspect, both of the first and second compositions comprise a reducing agent.

Optionally according to the tenth aspect, the first and second compositions comprise the same reducing agent.

Optionally according to the tenth aspect, the first and second compositions comprise different reducing agents.

Optionally according to the tenth aspect, the reducing agent of the first and/or second composition is independently selected from the group consisting of alcohols, aldehydes, metal borohydrides, hydrazines, acids, metal hydroxides, metal citrates, and metal hypophosphite.

Optionally according to the tenth aspect, the acid reducing agent is HF.

The methods of the seventh, eighth, ninth and tenth aspects may each be carried out with any of the materials or compositions described with reference to the first aspect. Etched silicon produced by the method of the seventh, eighth, ninth or tenth aspects may be used to form an electrode, for example an electrode of a metal ion battery, as described with reference to the fourth and fifth aspects of the invention.

### DESCRIPTION OF THE DRAWINGS

The invention will now be described in more detail with reference to the Figures, in which:

FIG. 1 is a schematic illustration of a metal ion battery;

FIG. 2A is a schematic illustration of a process according to an embodiment of the invention using bulk silicon;

FIG. 2B is a schematic illustration of pillars formed by a process according to an embodiment of the invention;

FIG. 2C is a schematic illustration of porous silicon formed by a process according to an embodiment of the invention;

FIG. 3 is a schematic illustration of a process according to an embodiment of the invention using powdered silicon;

FIG. 4 is a schematic illustration of a negative templating process according to an embodiment of the invention;

FIGS. 5A and 5B are SEM images of metal coated on silicon particles formed by a method according to an embodiment of the invention;

FIGS. 6A and 6B are SEM images of metal coated on silicon particles formed by a comparative method;

FIG. 7A 7B is a SEM image illustrating etched silicon particles formed by a method according to an embodiment of the invention;

FIG. 7B is a SEM image illustrating etched silicon particles formed by a comparative method;

FIGS. 8A-8C are SEM images illustrating growth of silver on a silicon surface by a method according to an embodiment of the invention;

FIGS. 8D-8G are SEM images illustrating growth of silver on a silicon surface by a comparative method; and

FIGS. 9-14 are SEM images illustrating etched silicon particles formed by methods according to embodiments of the invention;

FIG. 15A is a SEM image using secondary electron detection showing silver formation on silicon particles using KOH in a method according to an embodiment of the invention;

FIG. 15B is a SEM image of particles as described in FIG. 15A obtained using backscattered detection;

FIG. 16A is a SEM image using secondary electron detection showing particles of FIG. 15A following exposure to HF;

FIG. 16B is a SEM image of particles as described in FIG. 16A obtained using backscattered detection;

FIG. 17A is a SEM image using secondary electron detection showing particles of FIG. 15A following etching;

FIG. 17B is a SEM image of particles as described in FIG. 17A obtained using backscattered detection;

FIG. 18 is a graph of observed exotherm vs time for formation of silver on silicon particles using KOH to form particles shown in FIG. 15A;

FIG. 19 is a SEM image of particles as described in FIG. 15A following dissolution of silver using nitric acid;

FIGS. 20A and 20B are SEM images showing silver formation on silicon particles using trisodium citrate in a method according to an embodiment of the invention; and

FIGS. 21A and 21B are SEM images showing particles of FIGS. 20A and 20B following etching;

FIG. 22A is an SEM image showing particles of high purity silicon following metal deposition using HF and etching according to a comparative process;

FIG. 22B is an SEM image showing particles of high purity silicon following metal deposition using Tollen's reagent and etching according to a process according to an embodiment of the invention; and

FIG. 22C is an SEM image showing particles of high purity silicon following metal deposition in a two-step process using Tollen's reagent in a first step and HF in a second step, and etching according to a process according to an embodiment of the invention.

### DETAILED DESCRIPTION OF THE INVENTION

The process of etching silicon includes a deposition stage in which metal is formed on the surface of the silicon to be etched, and a metal assisted chemical etching stage in which the silicon underlying the deposited metal is etched. Deposition is a nucleation stage.

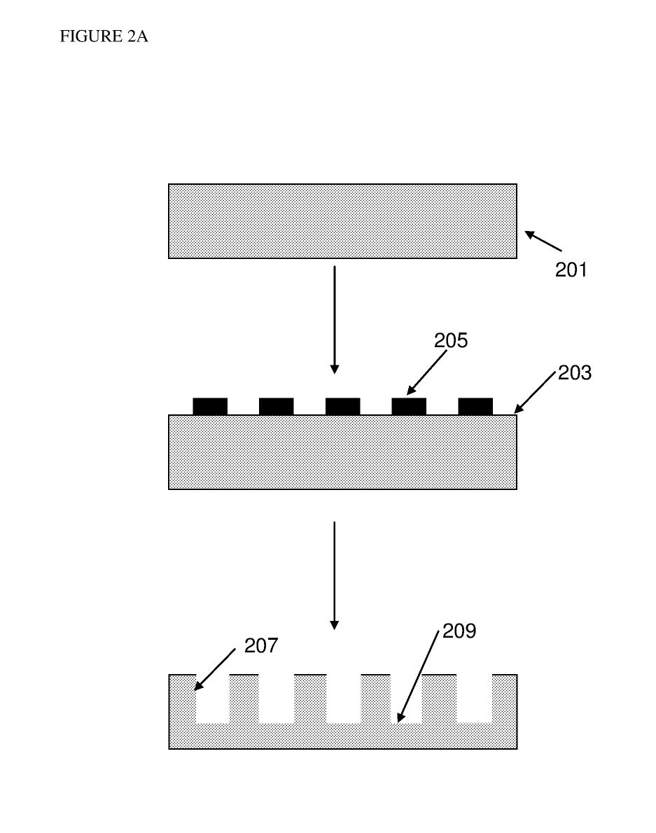

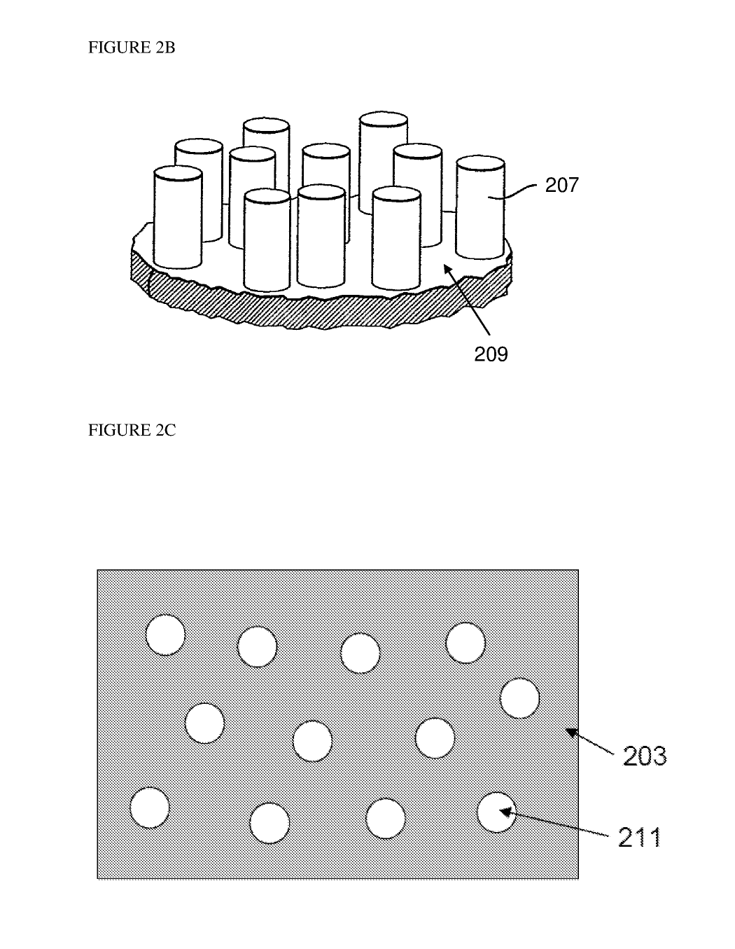

An exemplary etching process is illustrated in FIGS. 2A and 2B, which are not drawn to any scale. With reference to FIG. 2A, in a first stage elemental metal 205 is formed on a surface 203 of silicon wafer 201. In a second stage, the area underneath the deposited metal is etched in the presence of the oxidant and HF to form pillars 207 in the surface of the silicon.

FIGS. 2A and 2B illustrate etching at the surface of only one face of a multifaceted silicon wafer, however it will be appreciated that more than face, optionally all faces, of a multifaceted silicon material may be etched. For example, opposing faces of the silicon wafer of FIGS. 2A and 2B may be etched.

FIG. 2C illustrates etched silicon comprising pores 211 extending into the silicon formed by etching surface 203 to produce porous, eg mesoporous silicon or macroporous silicon (i.e. silicon with pores of diameter >50 nm). The process of etching silicon may be substantially the same as illustrated in FIG. 2A, except that the metal is deposited such that etching results in formation of pores 211 on the surface 203 of the silicon to be etched and extending downwards into the silicon material, rather than pillars 207 extending from an etched surface 209 of the etched silicon. In contrast to structured silicon having pillars, porous silicon may have a substantially continuous connected network of silicon walls at the outer surface of the silicon that has been etched.

Pillars 209, 309 may have any shape. For example, pillars may be branched or unbranched; substantially straight or bent; and of a substantially constant thickness or tapering. Pillars may contain steps.

With reference to FIG. 2B, the pillars 207 extending outwardly from, and may be spaced apart on, etched surface 209. The pillars may be wires, nanowires, rods and columns. The pillars may be detached from the etched surface 209 to form silicon fibres. In one arrangement, substantially all pillars 207 may be spaced apart. In another arrangement, some of the pillars 207 may be clustered together.

The cross-sections of the pillars may form regular shapes (e.g. circular, square or triangular) or be irregular in shape (e.g. may contain one or more concave or convex curved sides or branches or spurs extending outwards or combinations thereof). It will be appreciated that the shape of the pillars is at least partly determined by the shape of the exposed surface areas of silicon after metal deposition.

The surface of the etched silicon may comprise both regions of porous silicon and regions with pillars. The etched silicon may also combine regions of porous and pillared silicon in an inward extending direction. That is, an outer shell region of the etched silicon may comprise pillared silicon whilst the inner region comprises porous silicon and vice versa.

Pores may extend at least 100 nm, optionally at least 0.5 microns into the silicon from silicon surface 203, optionally at least 1 micron, optionally at least 2 microns. The pores may have a diameter of at least 10 nm, 20 nm, or 100 nm, optionally at least 300 nm, optionally at least 0.5 microns. The pores may extend inwards perpendicular to the silicon surface or may extend inwards at any intermediate angle. Not all pores may extend in the same direction, instead the plurality of pores may extend in a plurality of directions. The direction in which the pores extend inwards may change partway down. Two or more pores may join to form an irregular network of pores below the surface of the silicon.

Pillars may be formed by etching the silicon surface to a depth of more than 0.25 microns, more than 0.5 microns, optionally at least 1 micron, optionally at least 2 microns, optionally more than 10 microns. Optionally, the pillars are formed by etching the silicon surface to a depth in the range of 2-10 microns.

The pillars may have a diameter or thickness in the range of about 0.02 to 0.70 μm, e.g. 0.1 to 0.5 μm, for example 0.1 to 0.25 μm, preferably in the range 0.04 to 0.50 μm. The pillars may have an aspect ratio (defined as the height of the pillar divided by the average thickness or diameter of the pillar at its base) in the range 5:1 to 100:1, preferably in the range 10:1 to 100:1. The pillars may be substantially circular in cross-section but they need not be. Where the pillars have irregular cross-sections comprising a plurality of extended sections with changing direction and/or with branches or spurs then the average thickness of the plurality of such section is used in the calculation of the aspect ratio. The pillars may extend outwards from the silicon in any direction and may comprise kinks or changes in direction along their length.

The surfaces of pores or pillars may be relatively smooth or they may be rough. The surfaces may be pitted or comprise pores or voids with diameters less than 50 nm. The pillar structures may be solid; mesoporous; microporous or a combination thereof. The pillar structures may have a solid core with a mesoporous outer shell.

The porosity of the etched silicon may be defined as the percentage ratio of the total volume of the void space or pores introduced into the etched silicon to the volume of the silicon before etching. A higher porosity may provide a higher surface area which may increase the reactivity of the silicon in a device, for example in electrochemical cells, sensors, detectors, filters etc. or it may provide a larger volume for containing ingredients or active agents in medical or consumer product compositions. However, if the porosity is too large the structural integrity (or mechanical strength) of the silicon may be reduced and for example, in devices such as a lithium ion battery, the volume of electrochemically active silicon material is reduced. The porosity of the etched silicon may be at least 5%, optionally at least 10%. Preferably it is at least 20%, at least 40%, at least 50% or at least 50%. The porosity may be less than 95%, less than 90%, optionally less than 80%.

Dimensions of pores and pillars may be measured using optical methods, for example scanning electron microscopy. Porosity may be measured using known gas or mercury porosimetry techniques or by measuring the mass of the silicon material before and after etching.

FIGS. 2A-2C illustrate a process of etching a silicon wafer or sheet, however it will be appreciated that the same process may be applied to etching of silicon particles in order to form pores and/or pillars on the surface of the silicon particles. The shape, dimensions and arrangement on the etched surface of pillars and/or pores formed by etching of particles may be as described above with respect to FIGS. 2A-2C.

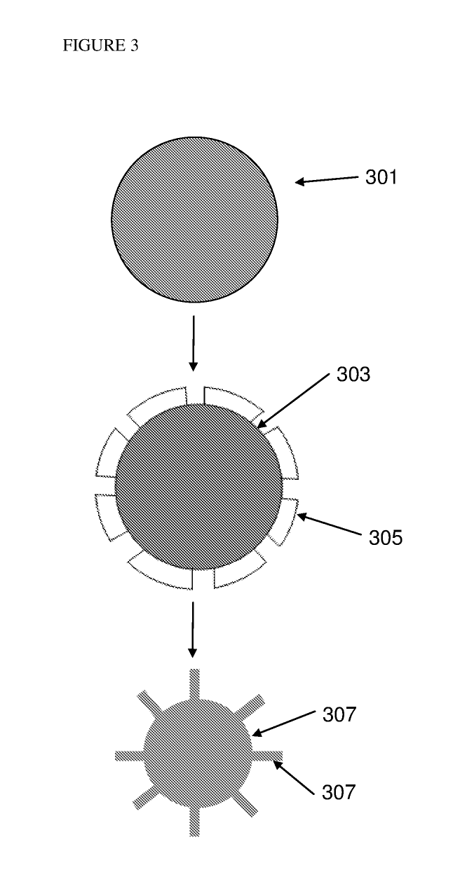

FIGS. 3A-3B illustrate a process of etching a silicon particle of a silicon powder. With reference to FIG. 3A, in a first stage elemental metal 305 is formed on a surface 303 of silicon particle 301. In a second stage, the area underneath the deposited metal is etched in the presence of the oxidant and HF to form pillars 307 extending from an etched surface 309. The etching process may produce pores as described with reference to FIG. 2C. The silicon powder may be immersed in the composition for deposition of the metal and in the etching composition such that all or substantially all of the surface of the particles are exposed to the metal deposition composition and to the etching composition.

Metal Formation and Etching

The source of the elemental metal formed on the surface of the silicon may be a source of elemental metal that is deposited onto the silicon surface without undergoing any chemical change, or may be a metal ion that is reduced to form the elemental metal.

If the source is an elemental metal then exemplary methods for depositing metal on the silicon surface include evaporation and sputtering of the metal, and printing or coating of a dispersion of metal particles, preferably an aqueous dispersion of metal nanoparticles.

Exemplary methods for depositing the nanoparticles to form metal on the the silicon surface include spin-coating and ink jet printing.

The metal may be deposited through or over one or more removable masks or templates to define a regular or irregular metal pattern on the surface of the silicon. Exemplary methods of applying a metal using a template are described in Huang et al, “Metal-Assisted Chemical Etching of Silicon: A Review”, Advanced Materials 2010, 1-24, the contents of which are enclosed herewith by reference. Methods such as these may allow more precise control over the size, spacing and arrangement of the resulting silicon structures formed by etching compared to electroless deposition. A suitable removable template can for example be provided by an arrangement of nanospheres or nanoparticles (e.g. SiO2 nanospheres) or by a patterned anodised aluminium film.

If the source is a metal ion then the metal may be electroles sly deposited on the silicon surface by exposure of the silicon surface to a composition containing the metal ions. This composition may contain a reducing agent to cause reduction of the metal ions to elemental metal that nucleates on the surface of the metal. Metal nucleates may form in the reducing composition before binding to the silicon surface. The metal ions may be provided in aqueous solution.

Electroless deposition of metals is described in Lin et al, “Aqueously Dispersed Silver Nanoparticle-Decorated Boron Nitride Nanosheets for Reusable, Thermal Oxidation-Resistant Surface Enhanced Raman Spectroscopy (SERS) Devices”, Applied Materials and Interfaces, 2012, 4, 1110-1117; Lv et al, “Long-Term Antimicrobial Effect of Silicon Nanowires Decorated with Silver Nanoparticles”, Adv. Mater. 2010, 22, 5463-5467; Shi et al, “Easy decoration of carbon nanotubes with well dispersed gold nanoparticles and the use of the material as an electrocatalyst” Carbon 47 (2009) 1146-1151; Ma et al, Silver nanoparticles decorated, flexible SiO₂ nanofibers with long-term antibacterial effect as reusable wound cover” Colloids and Surfaces A: Physicochem. Eng. Aspects 387 (2011) 57-64 Djokic et al, Electrodeposition and Electroless Deposition of Metallic Powders: A Comparison, ECS Transactions, 33 (18) 7-31 (2011); and Yae et al, New Surface-Activation-Process for Electroless Deposition of Adhesive Metal (Ni, Cu) Films on Si Substrates, ECS Transactions, 33 (18) 33-37 (2011), the contents of each of which are incorporated herein by reference.

Where a separate reducing agent is used, the silicon may be exposed to a solution of the metal ions followed by addition of the reducing agent, or the silicon may be exposed to the reducing followed by addition of a solution of the metal ions.

Exemplary reducing agents are alcohols including compounds with one or more than on hydroxyl group; aldehydes, for example sugars such as glucose, and glyoxal; sodium borohydride, hydrazine (hydrate), citric acid, ethylene glycol/polyvinylpyrolidone, hydroxides for example alkali hydroxides such as KOH and NaOH, metal citrates, for example trisodium citrate dehydrate, formaldehyde, sodium hypophosphite and ascorbic acid.

Exemplary metal ions that may be reduced are silver, gold, platinum and copper ions. Exemplary metal compounds containing these metal ions are AgNO₃, AuCl₄, silver acetate, copper sulphate pentahydrate, silver oxide, silver fluoride, silver trifluoroacetate, platinum chlorate and copper oxide. The metal ions may be metal complex ions, for example [Ag(NH₃)₂]⁺ ions, copper (II) tartrate ions and copper (II) citrate ions. The metal compounds are preferably water soluble. The composition comprising metal ions of the metal to be deposited may further comprise a brightening agent. Exemplary brightening agents include Epsom salts, Rochelle salts and metal cyanides. Brightening agents may affect the structure of the deposited metal, for example they may improve uniformity of distribution of the metal across the silicon surface.

A solution of the metal ions may be cooled or heated during metal deposition, for example to control the rate of metal deposition, which in turn may depend on the choice of reducing agent. An aqueous solution of the metal ions may be heated from about 50° C. to 100° C.

The reaction may be exothermic, and temperature change may be less than 10° C. The reaction may be endothermic.

Where silver nitrate is used, silver ions may be reduced by silicon oxide, or by Si—H bonds, at the surface of the silicon, in which case a separate reducing agent may not be required. The thickness of a native silicon oxide surface layer may be increased by heating.

Ammoniacal silver nitrate (Tollen's reagent) may be prepared by forming a silver oxide precipitate by reaction of silver nitrate and a hydroxide (Equation 3). The precipitate dissolves to form [Ag(NH₃)₂]⁺ NO3 upon addition of ammonia (Equation 4).

2AgNO₃ (aq)+2NaOH (aq)→Ag₂O (s)+2NaNO₃ (aq)+H₂O (l) (Equation 3)

Ag₂O (s)+4NH₃ (aq)+2NaNO₃ (aq)+H₂O (l)→2Ag(NH₃)₂NO₃ (aq)+2NaOH (aq) (Equation 4)

The composition comprising metal ions may have a pH greater than 7.

Where Tollen's reagent is used, the reduction takes place in the presence of a base, for example a metal hydroxide. The aldehyde is oxidized to release electrons (Equation 5) for reduction of the ammoniacal silver salt (Equation 6).

RCHO (aq)+3OH⁻→RCOO⁻+2H₂O+2e⁻ (Equation 5)

[Ag(NH₃)₂]⁺(aq)+e⁻→Ag (s)+2NH₃ (aq) (Equation 6)

R of Equation 5 is H or an organic residue, optionally alkyl.

Copper (II) ions in an aqueous solution containing copper (II) complex ions and an alkali, for example a carbonate or hydroxide, may likewise be reduced by an aldehyde. Exemplary solutions that may be reduced include Fehling's solution and Benedict's solution.

The aqueous solution may be heated before, during or after addition of aldehyde. The solution may be heated up to 80° C. The reaction may be endothermic. Elemental metal may be formed on the surface of the silicon either by reduction at the silicon surface in a process, for example by a process wherein electrons liberated from the silicon surface reduce the metal ions, or by reduction remote from the silicon surface followed by deposition of the elemental metal on the silicon surface, for example by the process described with reference to Equations (5) and (6), followed by deposition of the elemental metal on the surface of the silicon.

Overall safety of a metal deposition and etching process may be improved by avoiding use of hydrogen fluoride in a metal deposition stage, particularly at large scale of metal deposition.

The silicon material may be cleaned or otherwise treated prior to electroless deposition of the metal. Exemplary materials for washing of silicon include Bronsted (protonic) acids, for example nitric acid, Lewis acids, for example tin chloride, hydroxides, for example ammonium hydroxide, and peroxides, for example hydrogen peroxide. A preferred treatment (e.g. cleaning) composition is a mixture hydrogen peroxide and ammonium hydroxide. The treatment (e.g. cleaning) composition may be heated during cleaning. Heating may be up to 100° C., optionally up to 90° C.

The treatment may remove silicon oxide at the surface of the silicon starting material.

The silicon starting material may be provided in an amount of at least 1 gram per litre of the composition containing metal ions, optionally at least 5 g/L, optionally at least 10 g/L, and optionally up to about 30 g/L.

The weight ratio of silicon starting material:metal compound may be in the range of 3:1-1:2, optionally 2:1-1:2. For example, in the case where Tollen's reagent is used, the metal compound weight is weight of silver nitrate used to form the Tollen's reagent. Using an excess of metal ions in the composition during the metal deposition stage is not preferred. An excess is defined as an amount of metal ions that is in excess of the amount required to form a uniform covering of metal nucleates on all silicon surfaces to be etched at a surface density required to form the desired etched structures during the etching phase. An excess of metal ions may increase the processing cost and is believed to be deleterious to the quality of the etched structures. Metal deposition using HF typically requires a relatively high amount of metal compound to form a uniform coating over all silicon surfaces, and so avoiding use of HF may reduce the amount of metal compound needed which is particularly advantageous for costly metals such as silver. Excess metal ions that do not deposit onto a silicon surface may form metal dendrites or other metal structures in the composition.

The amount of metal ions used in the nucleation phase may be adjusted to take account of the mass and surface area of the silicon to be etched. It is useful to define the relative molar amount of metal ions used in terms of the number of moles of metal ions per unit surface area of silicon mass. The relative amount of metal ions, Rₘₑₜ can be defined as:

Rₘₑₜ=Mₘₑₜ/(M_{Si}×BET),

where Mₘₑₜ is the moles of metal ions used in the composition, M_{Si} is the mass of silicon being etched and BET is the surface area per unit mass of the silicon measured by the Brunauer-Emmett-Teller method.

For etching a plurality of pillars into the silicon surface, metal deposition using HF typically requires the relative amount of metal ions used, Rₘₑₜ to be up 5-9 millimoles or even up to 12 millmoles per square meter of silicon surface area, especially when etching a particulate (powder) silicon material. This amount typically provides an excess of metal ions but is necessary to achieve nucleation at the necessary density on the majority of silicon surfaces.

However, the inventors have found that with HF-free methods of nucleation as described herein, the same or better quality of nucleation can be achieved using a smaller value of Rₘₑₜ, Optionally, no more than 6 millimoles of metal ions are provided per square metre of silicon surface area, preferably no more than 4.5 millimoles, or no more than 3 millimoles. Optionally, for etching pillar structures, at least 0.5 millimoles of metal ions are provided. At values of Rₘₑₜ less than 0.5 millmoles, the etched structures are typically discrete pores rather than pillar structures.

Electroless deposition of a metal using a composition that is substantially free of HF, and preferably free of any fluoride ions, may avoid formation of hydrophobic silicon with Si—H bonds at the silicon surface.

Metal formation may take place in two or more stages, each stage being carried out in respective two or more compositions. In a first metal nucleation stage, silicon carrying relatively small and/or widely separated metal nucleates may be formed on the silicon surface by electroless deposition using a first composition containing metal ions that is substantially free of HF, preferably substantially free of fluoride ions.

Nucleation at the first nucleation stage may be stopped by removing the silicon from the first composition when a desired amount of metal has formed on the silicon surface.

In a second nucleation stage, the silicon may be exposed to a second composition containing metal ions that may or may not be the same as the first composition used. The compositions of the first and second nucleation stage may differ in one or more of components of the composition and concentration of components of the composition. The nucleates formed in the first nucleation stage may provide nucleation points for metal growth during the second nucleation stage.

The second composition may or may not contain fluoride ions, and may contain HF.

One or more further nucleation stages may be carried out, and the composition used at each stage may be the same as or different from the composition of each previous stage. Differences between further compositions of further nucleation stages may be as described above with respect to the first and second compositions.

In another arrangement, the first composition may contain a fluoride, for example HF, and at least one subsequent nucleation stage is carried out using a composition containing metal ions that is substantially free of HF, preferably substantially free of fluoride ions.

A plurality of nucleation stages may provide greater control over distribution of metal nucleates as compared to a process having only one nucleation stage prior to etching.

The metal that partially covers the surface of the silicon by electroless deposition of the metal using a composition that is substantially free of HF, preferably substantially free of fluoride ions, may also be the metal that is used in metal-assisted chemical etching of the silicon—for example, as illustrated in FIGS. 2 and 3.

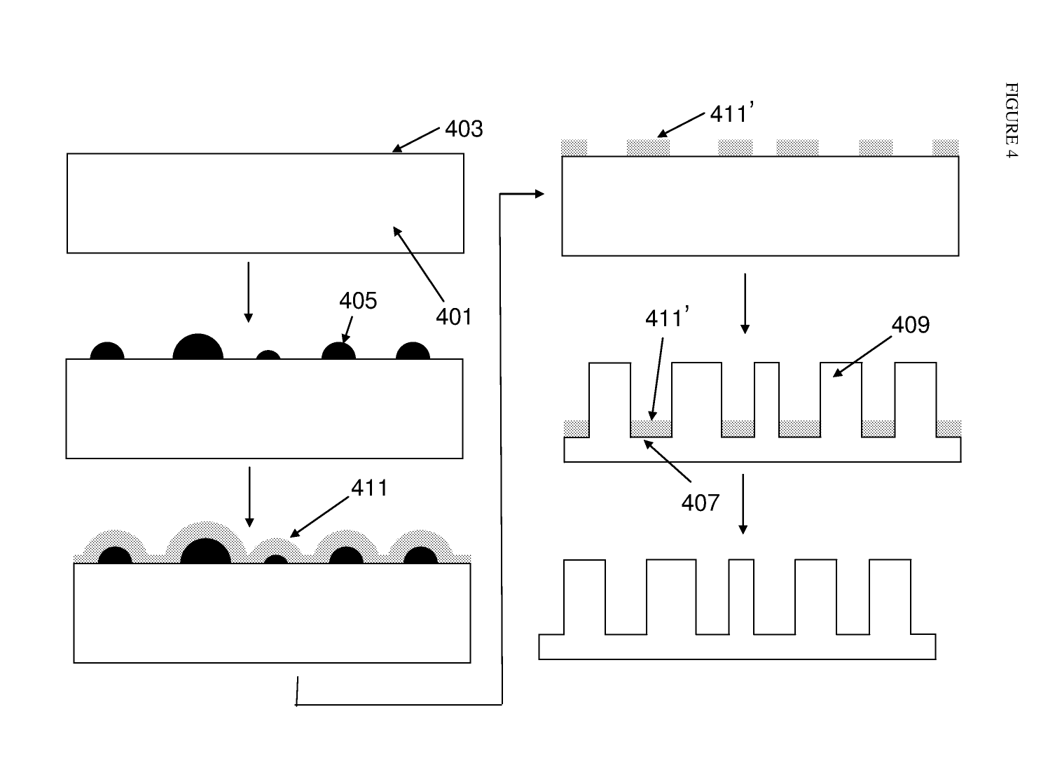

FIG. 4 illustrates a process in which a first metal 405 is deposited to partially cover a surface 403 of silicon 401 by electroless deposition of metal 405 from a composition containing metal ions that is substantially free of HF, preferably substantially free of fluoride ions, as described above. A second metal 411 is formed over substantially all of the silicon surface 403 to be etched. The first metal 405 is removed, along with the second metal in regions where the second metal overlies the first metal to leave the second metal 411′ partially covering the silicon surface. The remaining second metal 411′ is the metal used in metal-assisted chemical etching of the underlying silicon to produce pillars 409 extending from etched surface 407 of the silicon.

The second metal may be deposited by any process including, without limitation, evaporation or sputtering of the metal; coating or printing an ink containing particles of the metal; and electroless deposition. Electroless deposition may be carried out using a composition containing metal ions that is substantially free of HF, preferably substantially free of fluoride as described above, or may be carried out using a reducing composition that contains HF.

This “negative template” approach is described in more detail in UK patent application no 1122315.3, the contents of which are incorporated herein by reference. This process may be applied to bulk silicon and silicon powder, and may be used to form porous and/or pillared silicon.

The etching process may be as described in Huang et al, “Metal-Assisted Chemical Etching of Silicon: A Review”, Advanced Materials 2010, 1-24, the contents of which are incorporated herein by reference. Etching may take place in the presence of a fluoride, for example HF, and an oxidant. Nitrate oxidants are preferred, preferably alkali metal nitrates and ammonium nitrate.

The oxidant may be provided in a concentration of at least about 0.001 M, optionally at least about 0.01 M, optionally at least about 0.1 M in an aqueous etching solution. The oxidant may be provided in a concentration of up to about 1 M.

The aqueous etching solution may contain one or more solvents in addition to water, for example water-miscible organic solvents, for example one or more alcohols.

HF for etching may be provided in a concentration of at least 0.1 M, optionally about 1-10 M.

Silicon may be provided in an amount of up to 50 grams per litre of HF, optionally up to 40 g/L, optionally up to 20 g/L.

The mass of oxidant used, optionally ammonium nitrate, may be 1-3 times the mass of the starting silicon material, optionally 1-2 times the mass of the silicon starting material.

The concentration of HF in the etching stage, and/or the concentration of the oxidant in the etching stage, may be monitored during the deposition and/or etching process and adjusted as required.

The silicon may be irradiated during the metal deposition and/or etching steps. The intensity and wavelength of the light used will depend on the nature of the silicon being etched. The reaction material may be irradiated with a light source having a wavelength in the region of the bandgap of the silicon material being etched. The use of visible light is preferred. The light source may be ambient light; a lamp; or ambient light augmented by light emitted from a lamp.

The etching process may be carried out in any suitable reaction vessel, for example a vessel formed from a HF-resistant material, such as polyethylene or polypropylene or a reaction vessel lined with a HF resistant material such as a HF resistant rubber. If the silicon is irradiated then the vessel may be light-transmissive. Electroless deposition may likewise be carried out in such a reaction vessel.

Anisotropic etching may form structured silicon, in particular silicon carrying pillars or mesoporous or macroporous silicon.

Silicon Starting Material

The silicon to be etched may be undoped, n-doped, p-doped or a mixture thereof. Preferably, the silicon is n- or p-doped. Examples of p-type dopants for silicon include B, Al, In, Mg, Zn, Cd and Hg. Examples of n-type dopants for silicon include P, As, Sb and C. Dopants such as germanium and silver can also be used.

The silicon to be etched may be supported on a surface of another material.

The silicon may be pure silicon or may be an alloy or other mixture of silicon and one or more other materials. The silicon may have a purity of at least 90.00 wt %, optionally at least 99 wt %, optionally at least 99.8 weight %. Optionally the silicon purity may be less than 99.9999 wt %. The silicon may be metallurgical grade silicon.

The silicon may have a resistivity of between 0.0001-100 Ω·cm, preferably less than 1 Ω·cm, preferably less than 0.1 Ω·cm.

The starting silicon material may be crystalline or amorphous. Etching may be carried out on, for example, bulk silicon or on a silicon powder. Exemplary bulk silicon structures include silicon sheets such as silicon wafers or of metallurgical grade silicon, and silicon sheets or chips formed by breaking a silicon wafer into smaller pieces, or by breaking other forms of bulk silicon into sheets or flakes. Powder particles of silicon may be formed from a silicon source such as metallurgical grade silicon by any process known to the skilled person, for example by grinding or jetmilling bulk silicon to a desired size. Suitable example silicon powders are available as “Silgrain™” from Elkem of Norway.

Where used, bulk silicon such as a silicon wafer may have first and second opposing faces, the surface of each face having an area of at least 0.25 cm², optionally at least 0.5 cm², optionally at least 1 cm². Each face may be substantially planar. Bulk silicon may have a thickness of more than 0.5 micron, optionally more than 1 micron, optionally more than 10 microns, optionally more than 100 microns, optionally in the range of about 100-1000 microns.

Where used, particles may be in the form of flakes or wires, or cuboid, substantially spherical or spheroid particles. They may be multifaceted or may have substantially continuous curved surfaces. Non-spherical core particles may have an aspect ratio of at least 1.5:1, optionally at least 2:1.

The particles may have a size with a largest dimension up to about 100 μm, preferably less than 50 μm, more preferably less than 30 μm.

The particles may have at least one smallest dimension less than one micron. Preferably the smallest dimension is at least 0.5 microns.

Particle sizes may be measured using optical methods, for example scanning electron microscopy.

In a composition containing a plurality of particles, for example a powder, preferably at least 20%, more preferably at least 50% of the particles have smallest dimensions in the ranges described above. Particle size distribution may be measured using laser diffraction methods or optical digital imaging methods.

A distribution of the particle sizes of a powder of starting silicon particles used to form etched particles may be measured by laser diffraction, in which the particles being measured are typically assumed to be spherical, and in which particle size is expressed as a spherical equivalent volume diameter, for example using the Mastersizer™ particle size analyzer available from Malvern Instruments Ltd. A spherical equivalent volume diameter is the diameter of a sphere with the same volume as that of the particle being measured. If all particles in the powder being measured have the same density then the spherical equivalent volume diameter is equal to the spherical equivalent mass diameter which is the diameter of a sphere that has the same mass as the mass of the particle being measured. For measurement the powder is typically dispersed in a medium with a refractive index that is different to the refractive index of the powder material. A suitable dispersant for powders of the present invention is water. For a powder with different size dimensions such a particle size analyser provides a spherical equivalent volume diameter distribution curve.

Size distribution of particles in a powder measured in this way may be expressed as a diameter value Dn in which at least n % of the volume of the powder is formed from particles have a measured spherical equivalent volume diameter equal to or less than D.

Preferred size distributions for a powder of starting silicon particles include D50≦25 μm, optionally ≦15 μm, optionally ≦10 μm.

Surface area per unit mass of a starting silicon powder may be measured by various techniques including BET (Brunauer, Emmett and Teller) and laser diffractometry. The specific surface area measured using the BET technique may be at least 0.5 m²/g, preferably at least 1, 2 or 3 m²/g.

It will be appreciated that etching a starting material particle to produce a pillared particle, for example as described with reference to FIG. 3, then the resultant pillared particle will have a pillared particle core that is smaller than the starting material particle. A porous particle produced by etching a starting material may be substantially the same size as, or smaller than, the starting material. The material to be etched may consist essentially of silicon as described above, for example silicon having a purity of at least 90%, such as metallurgical grade silicon as described above, or it may contain one or more further materials. The material to be etched may have a non-silicon core, for example a core of graphite, and a silicon shell wherein the shell is etched.

Where the starting material has a silicon shell, the shell thickness may be greater than 0.5 microns, optionally in the range of 1-10 microns or 1-5 microns. The material having a non-silicon core may be a powder, and the non-silicon core of this material may have a diameter greater than 5 microns.

The starting silicon to be etched may have a surface layer of a silicon compound, for example a silicon oxide layer. Silicon may have a native silicon oxide surface layer which may have a thickness of about 1-2 nm. This may be increased by heating to a thickness of no more than 20 nm.

The surface of the silicon-containing material may include non-silicon materials.

Preferably, at least 5 weight % of the starting material is silicon.

Battery Formation

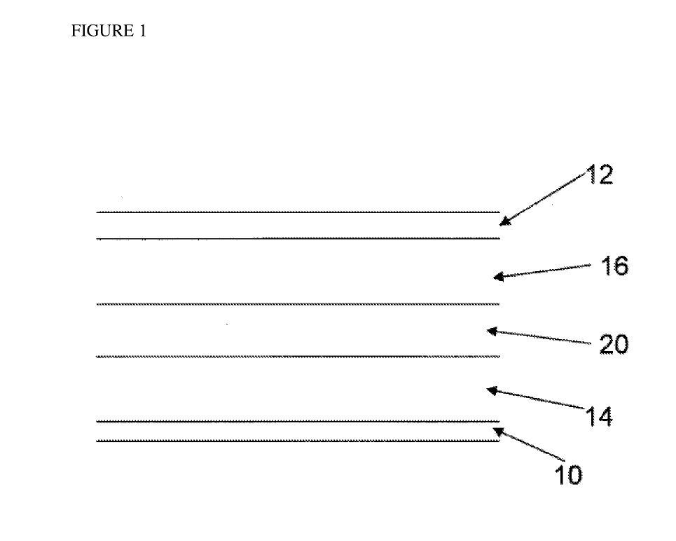

Etched silicon formed as described herein may be used to form the anode of a rechargeable metal ion battery. The metal ion battery may have a structure as described with respect to FIG. 1.

In the case where bulk silicon is etched, an anode current collector may be formed on one side of the bulk silicon and another side of the bulk silicon having an etched surface may come into contact with the electrolyte of the battery. The current collector may be a metal foil, for example copper, nickel or aluminium, or a non-metallic current collector such as carbon paper

In the case where the silicon is in the form of an etched powder, a slurry comprising the etched powder and one or more solvents may be deposited over an anode current collector to form an anode layer. The slurry may further comprise a binder material, for example polyimide, polyacrylic acid (PAA) and alkali metal salts thereof, polyvinylalchol (PVA) and polyvinylidene fluoride (PVDF), sodium carboxymethylcellulose (Na-CMC) and optionally, non-active conductive additives, for example carbon black, carbon fibres, ketjen black or carbon nanotubes. In addition to providing the silicon powder to act as an active material in the battery, one or more further active materials may also be provided in the slurry. Exemplary further active materials include active forms of carbon such as graphite or graphene. Active graphite may provide for a larger number of charge/discharge cycles without significant loss of capacity than active silicon, whereas silicon may provide for a higher capacity than graphite. Accordingly, an electrode composition comprising a silicon-containing active material and a graphite active material may provide a lithium ion battery with the advantages of both high capacity and a large number of charge/discharge cycles. The slurry may be deposited on a current collector, which may be as described above. Further treatments may be done as required, for example to directly bond the silicon particles to each other and/or to the current collector. Binder material or other coatings may also be applied to the surface of the composite electrode layer after initial formation.

Examples of suitable cathode materials include LiCoO₂, LiCo_{0.99}Al_{0.01}O₂, LiNiO₂, LiMnO₂, LiCo_{0.5}Ni_{0.5}O₂, LiCo_{0.7}Ni_{0.3}O₂, LiCO_{0.8}Ni_{0.2}O₂, LiCo_{0.82}Ni_{0.18}O₂, LiCo_{0.8}Ni_{0.15}Al_{0.05}O₂, LiNi_{0.4}Co_{0.3}Mn_{0.3}O₂ and LiNi_{0.33}Co_{0.33}Mn_{0.34}O₂. The cathode current collector is generally of a thickness of between 3 to 500 μm. Examples of materials that can be used as the cathode current collector include aluminium, stainless steel, nickel, titanium and sintered carbon.

The electrolyte is suitably a non-aqueous electrolyte containing a lithium salt and may include, without limitation, non-aqueous electrolytic solutions, solid electrolytes and inorganic solid electrolytes. Examples of non-aqueous electrolyte solutions that can be used include non-protic organic solvents such as propylene carbonate, ethylene carbonate, butylenes carbonate, dimethyl carbonate, diethyl carbonate, gamma butyrolactone, 1,2-dimethoxy ethane, 2-methyl tetrahydrofuran, dimethylsulphoxide, 1,3-dioxolane, formamide, dimethylformamide, acetonitrile, nitromethane, methylformate, methyl acetate, phosphoric acid trimester, trimethoxy methane, sulpholane, methyl sulpholane and 1,3-dimethyl-2-imidazolidione.

Examples of organic solid electrolytes include polyethylene derivatives polyethyleneoxide derivatives, polypropylene oxide derivatives, phosphoric acid ester polymers, polyester sulphide, polyvinyl alcohols, polyvinylidine fluoride and polymers containing ionic dissociation groups.

Examples of inorganic solid electrolytes include nitrides, halides and sulphides of lithium salts such as Li₅NI₂, Li₃N, LiI, LiSiO₄, Li₂SiS₃, Li₄SiO₄, LiOH and Li₃PO₄.

The lithium salt is suitably soluble in the chosen solvent or mixture of solvents. Examples of suitable lithium salts include LiCl, LiBr, LiI, LiClO₄, LiBF₄, LiBC₄O₈, LiPF₆, LiCF₃SO₃, LiAsF₆, LiSbF₆, LiAlCl₄, CH₃SO₃Li and CF₃SO₃Li.

Where the electrolyte is a non-aqueous organic solution, the battery is provided with a separator interposed between the anode and the cathode. The separator is typically formed of an insulating material having high ion permeability and high mechanical strength. The separator typically has a pore diameter of between 0.01 and 100 μm and a thickness of between 5 and 300 μm. Examples of suitable electrode separators include a micro-porous polyethylene film.

### EXAMPLES

### Example 1

Silicon powder available from Elkem of Norway as Silgrain HQ jet-milled to a D₅₀ size of 4.6 microns and BET value of 2.4 m²/g (Powder 1) or 13.5 microns and BET value of 0.7 m²/g (Powder 2), was washed with a 1:1:1 volume mixture of water, 7.89 M ammonium hydroxide and 9.79 M hydrogen peroxide and heated to 80° C. for 10-20 minutes until evolution of bubbles stops. The silicon was then washed three times, for 10 minutes each time in a centrifuge with sulphuric acid. The powder was added to water. About 1 g of glucose per gram of silicon powder was added, and the mixture was stirred for 10-15 minutes.

Tollen's reagent was made by mixing silver nitrate in a mass that is 1.5 times that of the starting silicon with dropwise addition of 7.89 M ammonia until the solution went from clear to dark and then clear again. Potassium hydroxide was added in a ratio of about AgNO₃:KOH 1:1.3 in weight, followed by dropwise addition of ammonia as before.

The silicon powder/glucose mix was added to the Tollen's reagent, stirred for 1 minute and then allowed to stand for 5 minutes, during which time a silver mirror formed on the side of the container. The Tollen's reagent was then washed away and the remaining silicon washed 3 more times to give silver-coated silicon powder.

The silver-coated powder was placed in a solution having a HF concentration of about 2-10 M and ammonium nitrate concentration of about 1-100 mM. For Powder 1, Rₘₑₜ=3.6 millimoles per m².

### Comparative Example 1

For the purpose of comparison, etched silicon powder was prepared as described in Example 1, using Powder 1, except that silver was formed on the surface of the silicon powder by placing the powder in a solution of silver nitrate and HF for electroless deposition of silver as described in, for example, WO2009/010758.

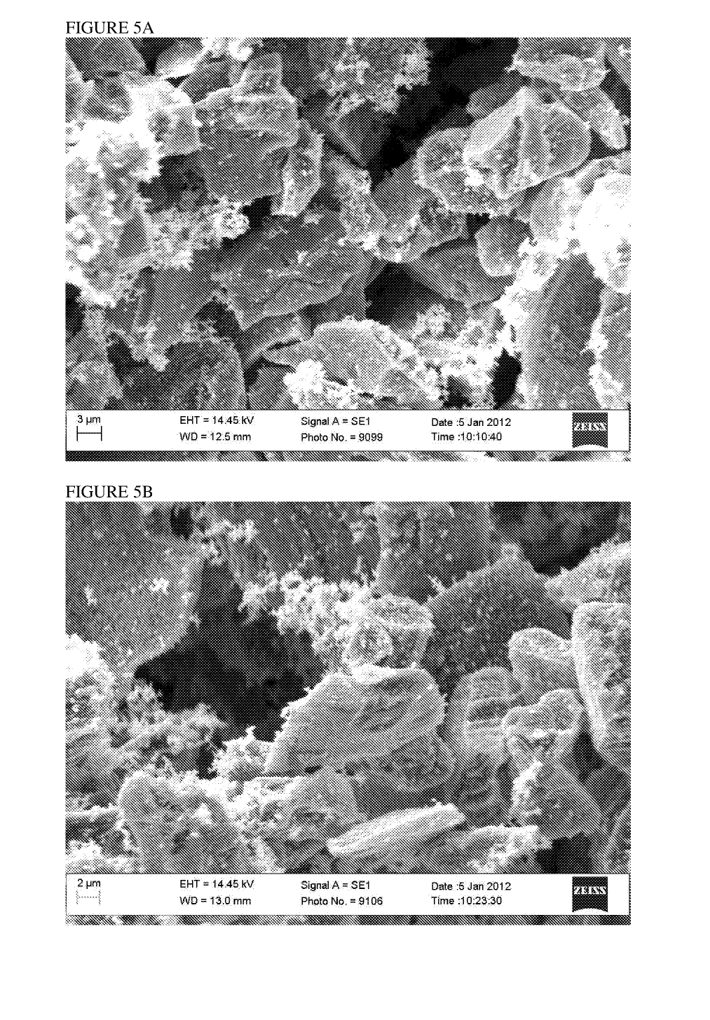

FIGS. 5A and 5B are SEM images of the silicon powder of Example 1, using Powder 1, following treatment with Tollen's reagent and before etching.

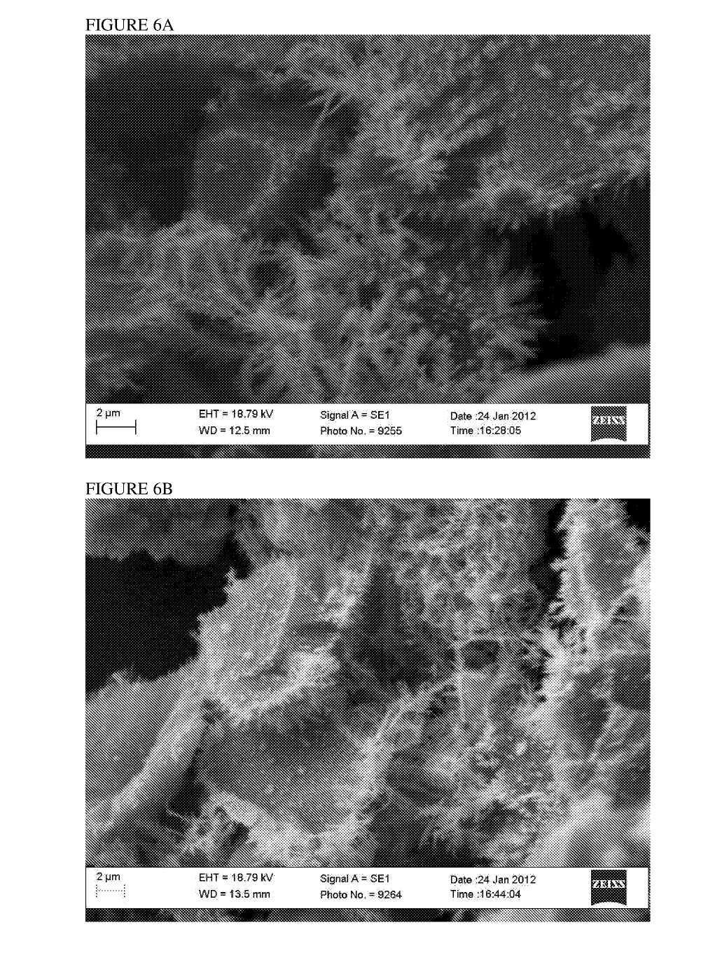

FIGS. 6A and 6B are SEM images of the silicon powder of Comparative Example 1, following electroless deposition of silver in the presence of HF and prior to etching.

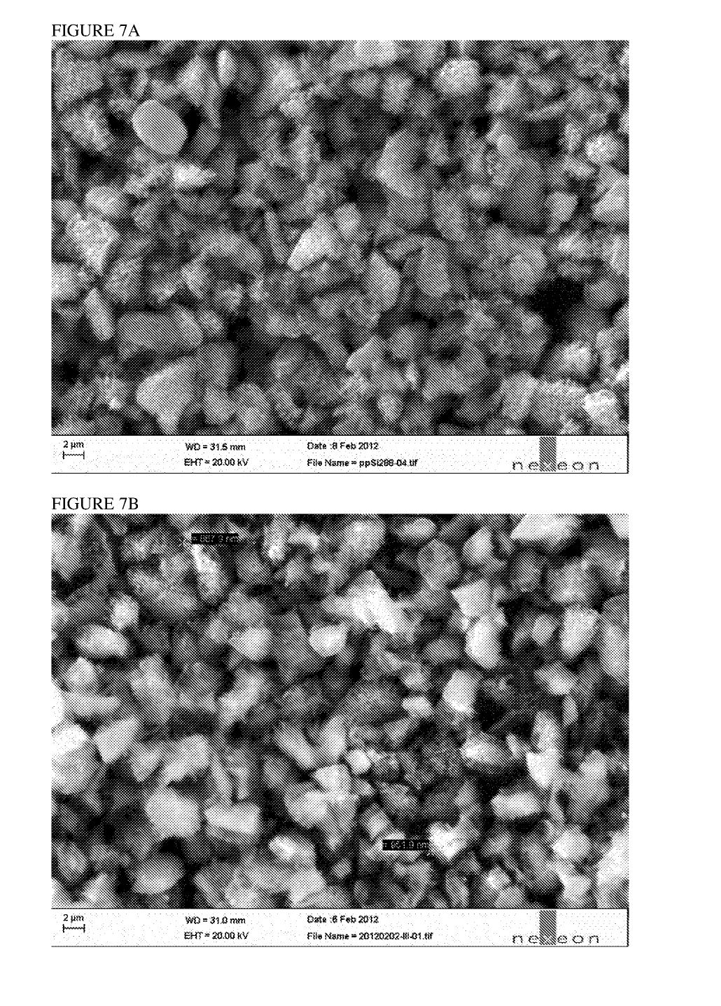

Substantially more silver formed on the silicon surface in Comparative Example 1 as compared to Example 1. This can be seen in the presence of substantially more dendrites of silver in FIGS. 6A and 6B than in FIGS. 5A and 5B. Despite the lower amount of silver formed on the silicon surface of FIG. 5A, etching of silicon coated by this method still produced well-defined pillars as shown in FIG. 7A. For the purpose of comparison, FIG. 7B shows etched silicon produced by electroless deposition of silver in the presence of HF. This indicates that etching of silicon without use of fluoride to deposit metal on the silicon surface may be carried out with less silver than a corresponding etch in which electroless deposition of silver takes place in the presence of HF.

Furthermore, electroless deposition in the presence of HF is a fast, exothermic reaction that generates hydrogen gas and causes the silicon to be H-terminated, making it hydrophobic.

It will be appreciated that a powder of small silicon particles, such as particles having a D₅₀ less than 25 microns or less than 15 microns, will have a high surface area to mass ratio which may result in a particularly strong exothermic reaction with rapid generation of gas. This, and formation of a hydrophobic silicon surface, may cause a substantial proportion of the powder to float to the top of the deposition mixture. The resulting rapid nucleation process may be very difficult to control, particularly for a large quantity of silicon, and may give uneven silver deposition which in turn may result in particles being poorly etched or not etched at all.

Metal formation in Example 1 is an endothermic process. The process of Example 1 provides greater control over formation of silver on the surface of the silicon, and therefore greater control over the etching process, and may allow more a greater amount of silicon to be etched per unit volume of the composition containing metal ions

Data for etched silicon particles produced by Example 1 and Comparative Example 1 are provided in the table below.

| | | | Comparative |
|---|---|---|---|
| | | Example 1 | Example 1 |
| Yield | | 33% | 19% |
| Mastersize | D10 | 2.7 | 2.21 |
| (microns) | D50 | 4.6 | 3.88 |
| | D90 | 7.8 | 6.52 |

The yield of Example 1 is higher than that of Comparative Example 1, and particle sizes are larger, showing that less silicon is lost in the process of the invention. Without wishing to be bound by any theory, it is believed that this loss is due to etching by HF at the silicon surface during the metal nucleation stage, resulting in a porous silicon surface that is lost during the etching stage.

### Example 2

A silicon wafer was cut into 1×2 cm² slides, prewashed with H₂O₂(30%):NH₃(28%):H₂O=1:1:1 solution, and boiled for 15 min.

Tollen's reagent was prepared by adding 5 g AgNO₃ powder to 1 L of deionised water. 28% NH₃.H₂O was added to this above solution until its colour changed from dark to clear. KOH solution was added, causing the mixture to become dark, then 28% NH₃.H₂O was slowly added dropwise until the solution become clear again.

The wafer was placed in the reagent, and glucose was added.

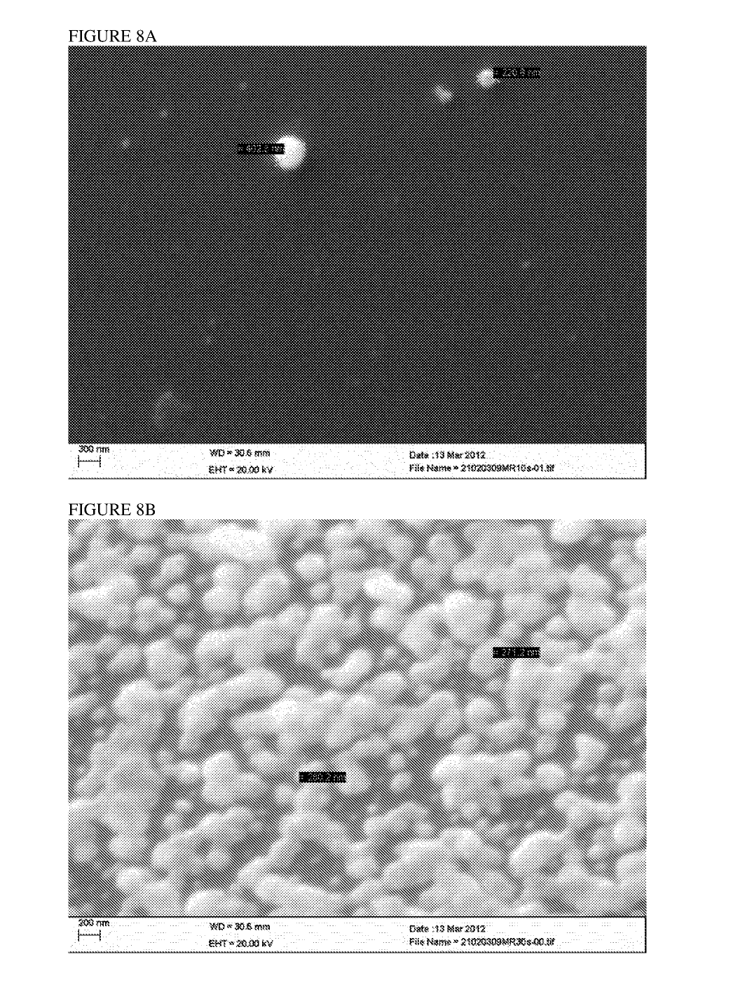

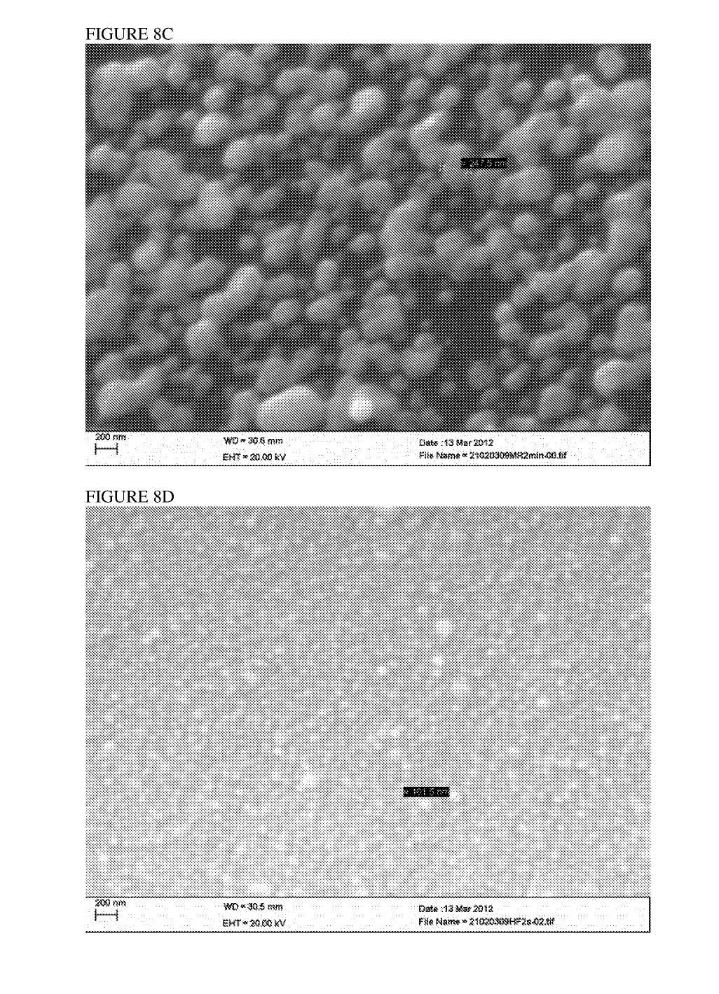

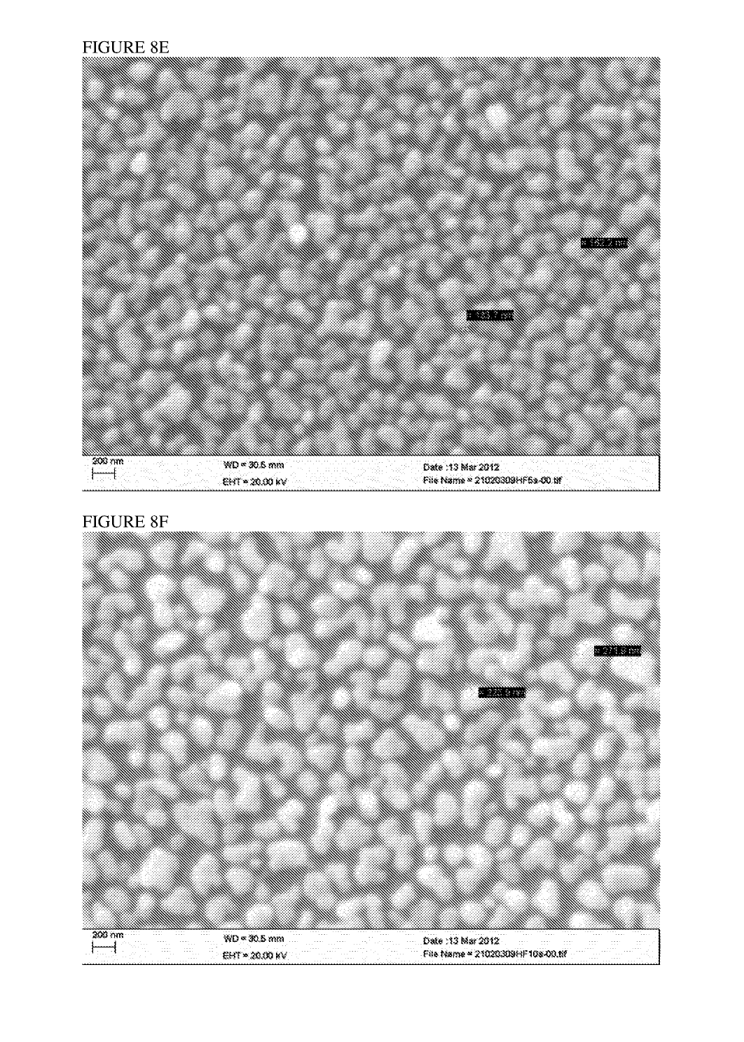

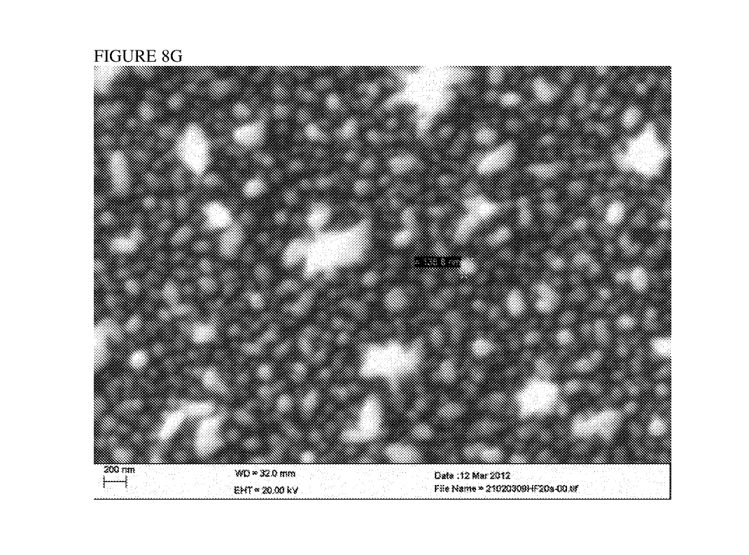

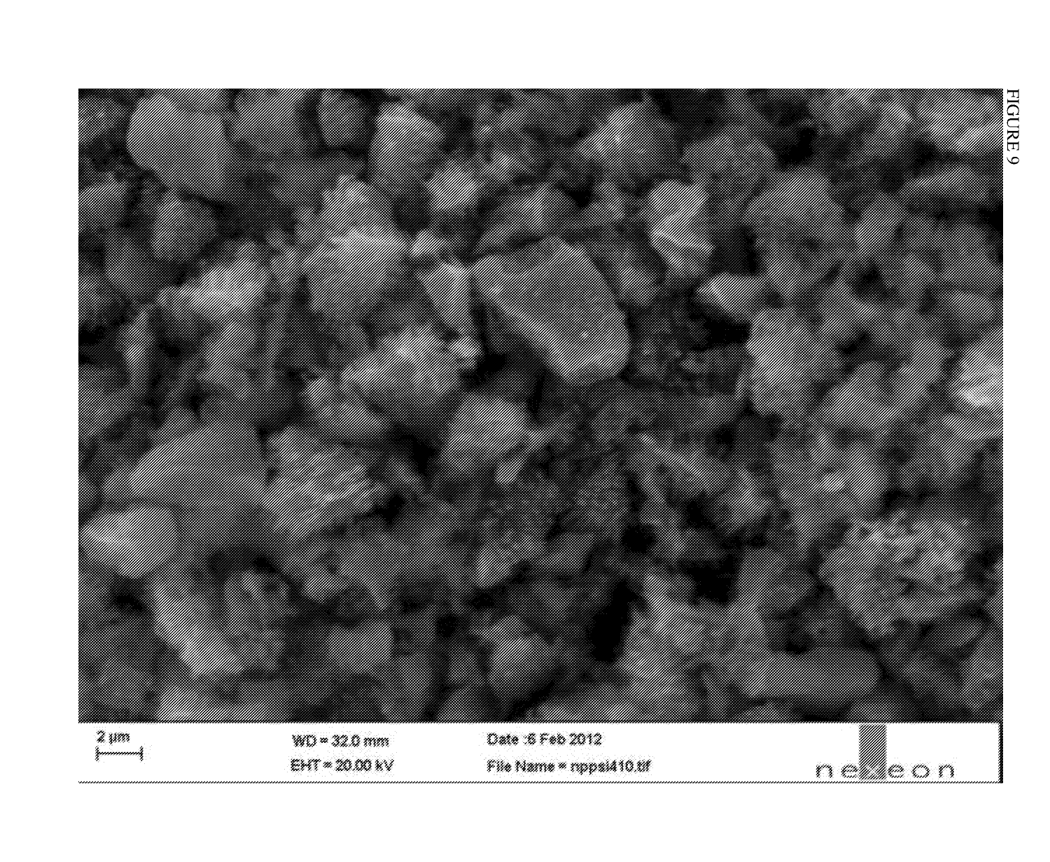

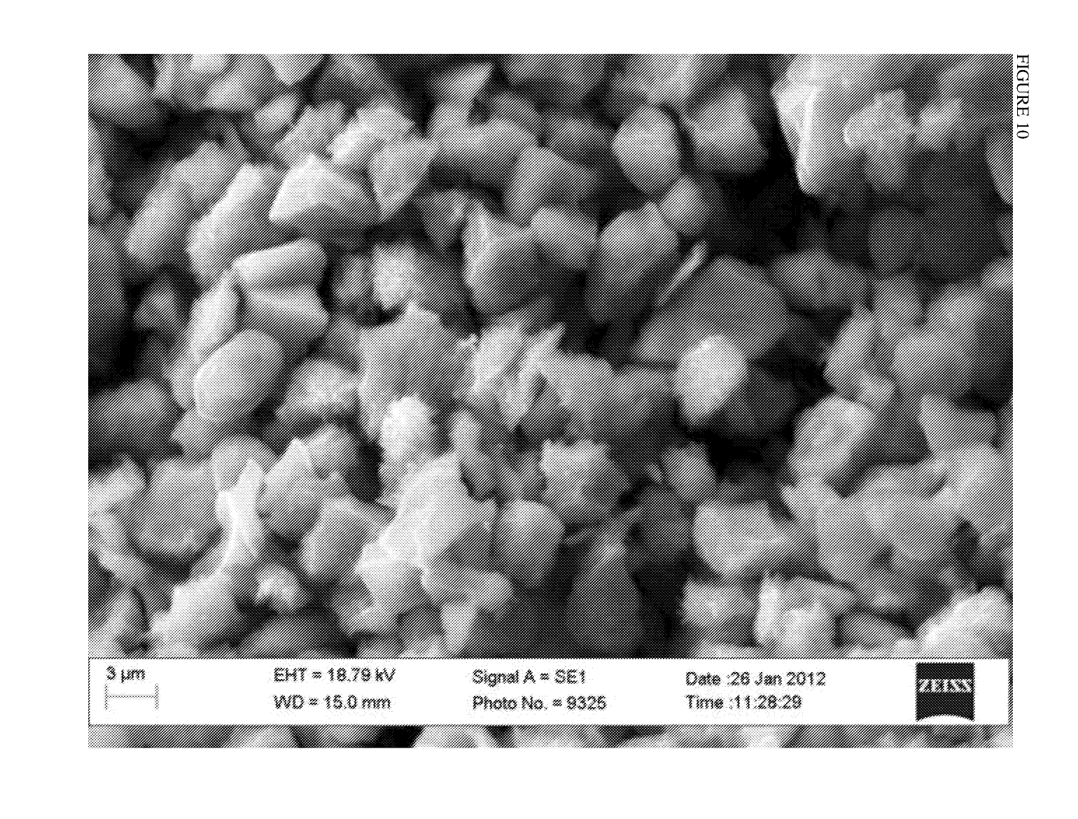

FIGS. 8A-C are SEM images illustrate formation of silver particles on the surface of the wafer after 10 seconds, 30 seconds and 2 minutes respectively. The deposition may be stopped at any stage by removing the wafer and washing with deionised water, enabling control over the extent of silver deposition.

For comparison, FIGS. 8D-8G show the same process using a composition of 1 Litre 7.5M HF+29.4 mM AgNO3 (5 grams in 1 litre solution) at 2, 5, 10 and 20 seconds respectively. It can be seen that nucleation is very rapid and as such is harder to control when fluoride is used in the metal formation stage.

### Example 3

Etching was carried out as described in Example 1 using Powder 1, except that the silicon starting material was treated with nitric acid instead of the 1:1:1 volume mixture of water, 7.89 M ammonium hydroxide and 9.79 M hydrogen peroxide.

FIG. 9 is a SEM image of the etched material produced by this method.

### Example 4

Etching was carried out as described in Example 1 using Powder 1, except that the silicon starting material was treated with SnCl₂ instead of the 1:1:1 volume mixture of water, 7.89 M ammonium hydroxide and 9.79 M hydrogen peroxide.

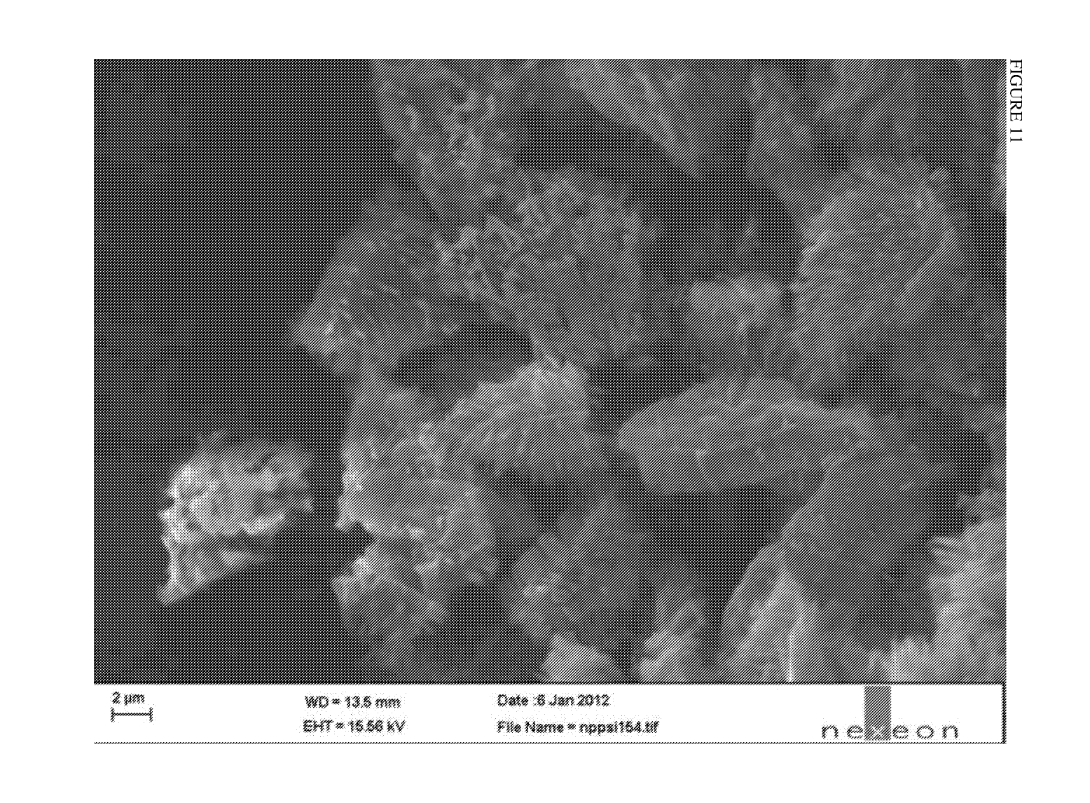

FIG. 10 is a SEM image of the etched material produced by this method.

### Example 5

Etching was carried out as described in Example 1 using Powder 1, except that the silicon starting material was not treated with the 1:1:1 volume mixture of water, 7.89 M ammonium hydroxide and 9.79 M hydrogen peroxide.

FIG. 11 is a SEM image of the etched material produced by this method.

FIGS. 8-11 show that etching of silicon occurs for all silicon pre-treatments, or for no silicon pre-treatment, with most etching occurring upon treatment with water, ammonium hydroxide and hydrogen peroxide. Accordingly, etching may be controlled at least in part by choice of the silicon pre-treatment used.

### Example 6

Etching was carried out as described in Example 1 using Powder 1, wherein the weight ratio of silicon:silver nitrate:ammonium nitrate was 1:1.5:1.75. The mixture was not stirred during etching.

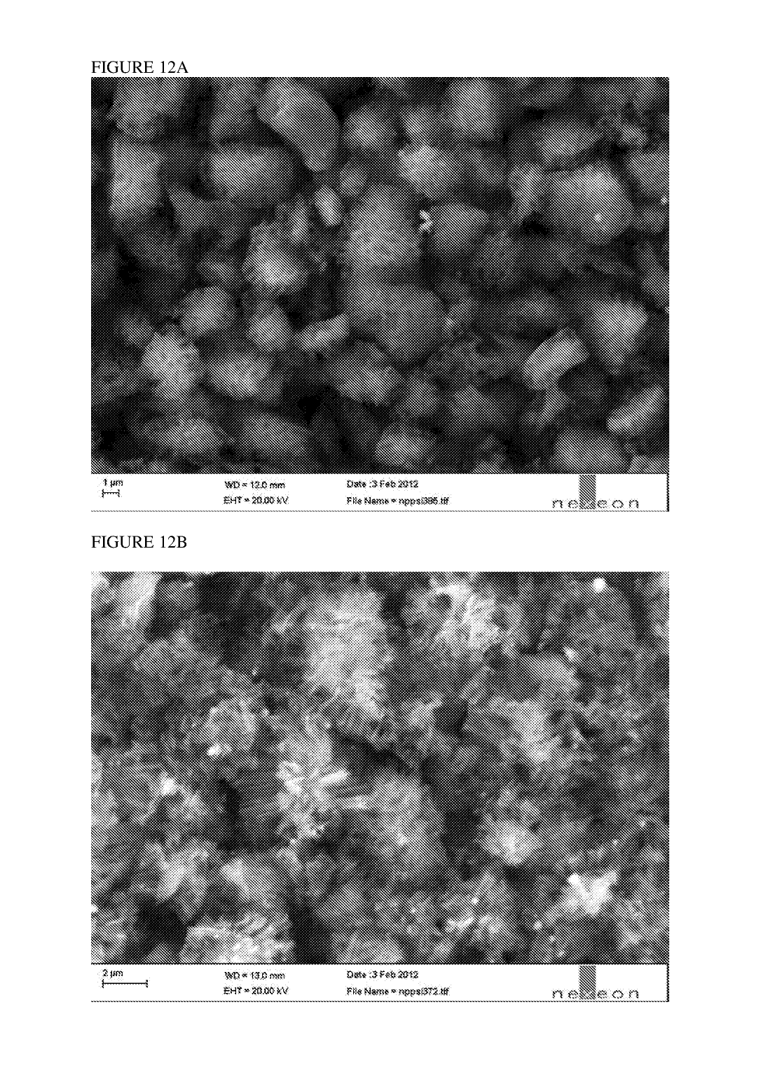

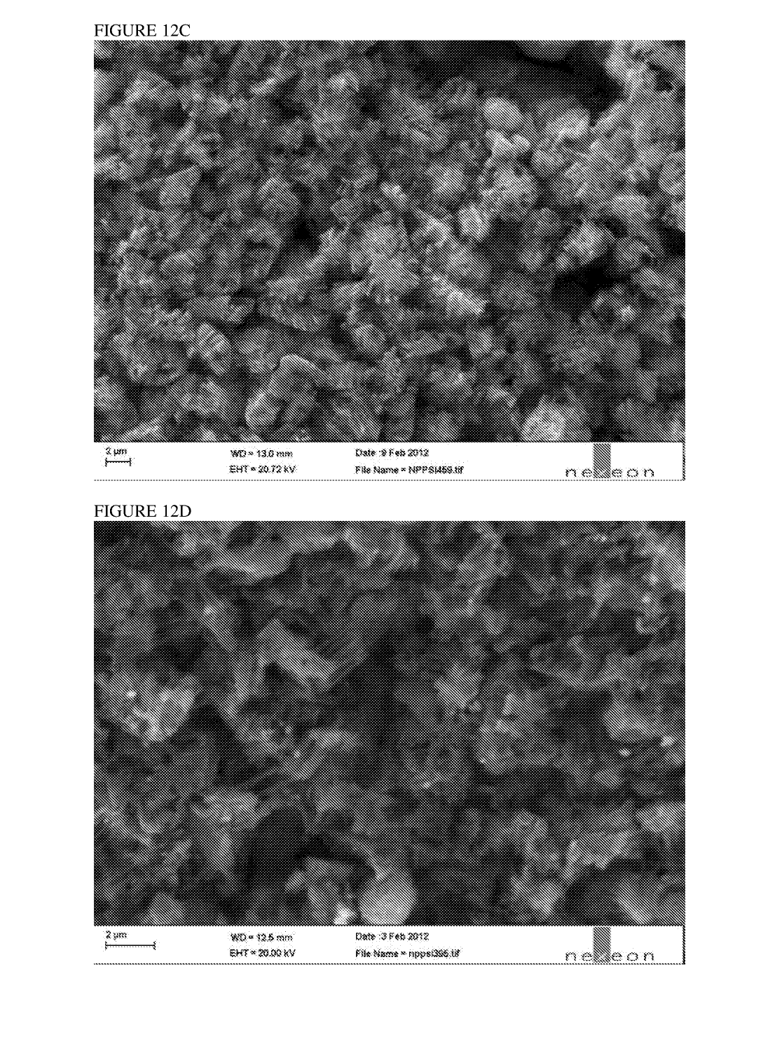

FIG. 12A is a SEM image of the etched material produced by this method.

### Example 7

Etching was carried out as described in Example 6 using Powder 1, wherein the mixture was stirred at about 100 rpm during etching.

FIG. 12B is a SEM image of the etched material produced by this method.

It can be seen that stirring has a significant effect on the etched material produced.

### Example 8

Etching was carried out as described in Example 6 using Powder 1, except that the weight ratio of silicon:silver nitrate:ammonium nitrate was 1:1.5:2.

FIG. 12C is a SEM image of the etched material produced by this method.

### Example 9

Etching was carried out as described in Example 6 using Powder 1, except that the weight ratio of silicon:silver nitrate:ammonium nitrate was 1:1.5:2.25.

FIG. 12D is a SEM image of the etched material produced by this method.

### Example 10

Etching was carried out as described in Example 1 using Powder 1, wherein the weight ratio of silicon:silver nitrate:ammonium nitrate was 1:1.5:2 and 5 g of silicon per litre of HF was used. The mixture was not stirred.

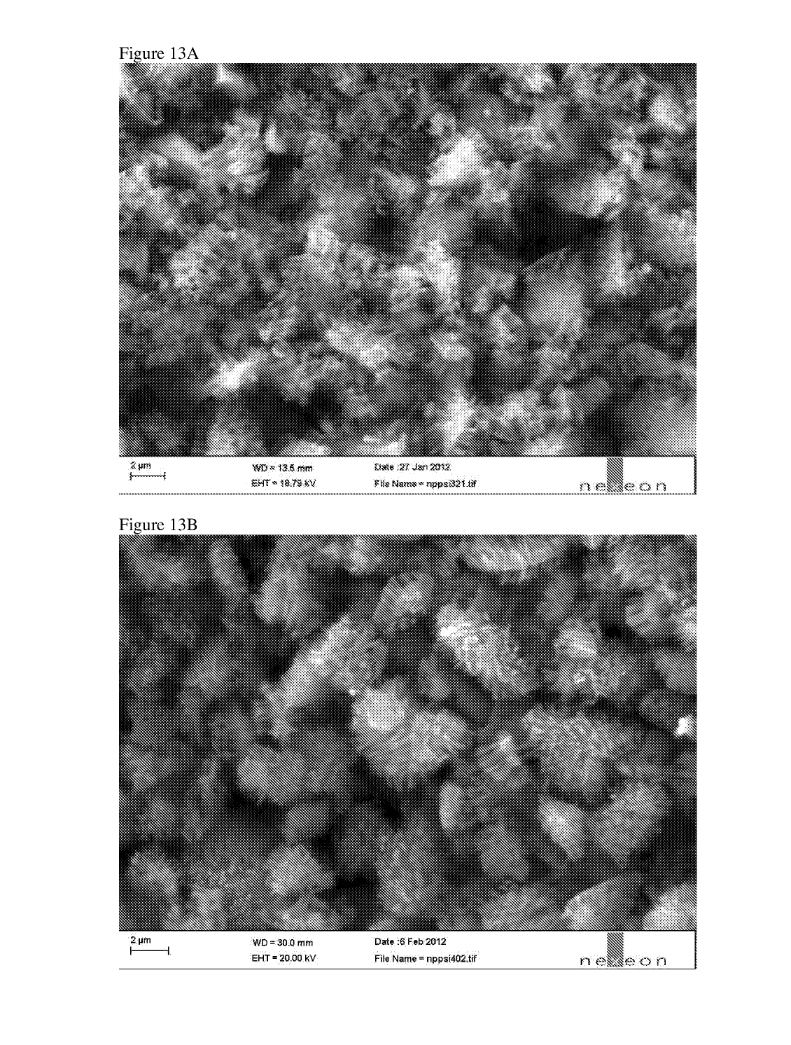

FIG. 13A is a SEM image of the etched material produced by this method.

### Example 11

Etching was carried out as described in Example 10, except that the weight ratio of silicon:silver nitrate:ammonium nitrate was 1:1.5:1.75 and 10 g of silicon per litre of the etching composition was used.

FIG. 13B is a SEM image of the etched material produced by this method.

### Example 12

Etching was carried out as described in Example 10 using Powder 1, except that the weight ratio of silicon:silver nitrate:ammonium nitrate was 1:1.5:1.75 and 20 g of silicon per litre of the etching composition was used.

FIG. 13C is a SEM image of the etched material produced by this method.

### Example 13

Etching was carried out as described in Example 10 using Powder 1, except that the weight ratio of silicon:silver nitrate:ammonium nitrate was 1:1.5:1.5; 20 g of silicon per litre of the etching composition was used; and the mixture was stirred during etching.

FIG. 13D is a SEM image of the etched material produced by this method.

As can be seen from FIGS. 13A-13D, silicon may be etched to produce pillars at silicon loadings of up to 20 g/L.

### Example 14

Etching was carried out as described in Example 1 using Powder 1, wherein the weight ratio of silicon:silver nitrate:ammonium nitrate was 1:0.5:2 and 5 g of silicon per litre of the etching composition was used. In this case, Rₘₑₜ=1.2 millimoles per m².

FIG. 14A is a SEM image of the etched material produced by this method to produce porous silicon, rather than pillared silicon particles, which is attributed relatively low amount of silver nitrate used.

### Example 15

Etching was carried out as described in Example 14, except that the weight ratio of silicon:silver nitrate:ammonium nitrate was 1:1:2. In this case Rₘₑₜ=2.4 millimoles per m².

FIG. 14B is a SEM image of the etched material produced by this method.

It can be seen from FIG. 14A that etching where a low silver nitrate concentration was used in deposition of silver tends to produce porous silicon, whereas pillars are produced at the higher concentration used in Example 14 (FIG. 14B) and in Example 10 (FIG. 13A).

### Example 16

Etching was carried out as described in Example 1. For the etching process, silver-coated silicon was added to 80 litres of 7.5 MHF solution.

A 50% NH₄NO₃ solution (1:1 solution of NH₄NO₃:water by weight, 6.25M) was pumped into the reaction vessel at constant rate so that the nitrate was slowly added over approximately 1.5 hours with continuous stirring.

After all NH₄NO₃ was added, the mixture was left for 5-30 minutes and the etching composition was drained off. The etched silicon product was washed with deionised water and nitric acid to remove and recover the silver, followed by several washes in deionised water to clean the etched silicon.

Data for the etched particles produced is shown in the table below. OMF is the Oxidisable Mass Fraction of the particles, and is an indication of the percentage of the particle available for oxidation.

| Feedstock | | | | | | | | | |
|---|---|---|---|---|---|---|---|---|---|
| D50 | | Si loading | | | ppSi | Pillar | | | |
| (microns) | | (g per litre HF | Si:AgNO3:NH4NO3 | Stirring | D10/D50/D90 | length | BET | OMF | Yield |
| and sample # | | solution) | weight ratio | (rpm) | (μm) | (μm) | (m²/g) | (%) | (%) |
| 13.5 | 1 | 8 | 1:0.5:1.44 | 30 | | 2 | 44.8 | 25 | 30 |
| 13.5 | 2 | 8 | 1:0.5:1.44 | 30 | | | 48.29 | 30 | 30 |
| 4.6 | 3 | 9.8 | 1:1.5:0.88 | 180 | 2.0/3.6/6.2 | 0.7 | 18.24 | 24 | 51 |
| 4.6 | 4 | 9.5 | 1:1:1.05 | 180 | 2.8/4.7/7.5 | 0.7 | 18.85 | 30 | 37 |
| 4.6 | 5 | 3.1 | 1:1:1.05 | 30 | 2.6/4.5/8.2 | 0.9 | 25.16 | 31 | 34 |
| 4.6 | 6 | 9.5 | 1:1.1:1.05 | 30 | | 0.9 | 39.17 | 66 | 26 |
| 4.6 | 7 | 3.1 | 1:1:1.05 | 30 | | 0.9 | 24.47 | 32 | 33 |
| 4.6 | 8 | 9.5 | 1:1.1:1.05 | 30 | | | | | 38 |
| 4.6 | 9 | 9.4 | 1:0.5:1 | 180 | 2.5/4.7/9.6 | n/a | 40.26 | 77 | 31 |

### Example 17

15 g of silicon powder available from Elkem of Norway as Silgrain HQ jet-milled to a D₅₀ size of 13.5 microns, and having a BET value of 0.7 m²/g, was suspended in 100 mL ethanol and stirred. To this was added 100 mL 1 M KOH solution, and the resulting suspension stirred at room temperature for 10 min. To this was added 100 mL 1 M AgNO₃ solution, and the solution stirred for a final 5 min. The solid was collected by filtration and washed with 100 mL H₂O.

The solid was re-suspended in 600 mL H₂O, and 300 mL 25 M HF was added with stirring. Stirring was continued for 1 min, before allowing the reaction to rest for 15 min. 5.0 g 50% wt/wt NH₄NO₃ solution was added four times, with a 15 min rest period between each addition.

After the final batch of oxidant the reaction was allowed to rest for 30 min, before the supernatant was decanted away, and the resulting mixture containing silicon particles washed with 3×100 mL H₂O. The silver was removed with 20% v/v HNO₃ and the product collected by filtration. The silicon powder was washed with 3×100 mL H₂O and dried overnight in an oven.

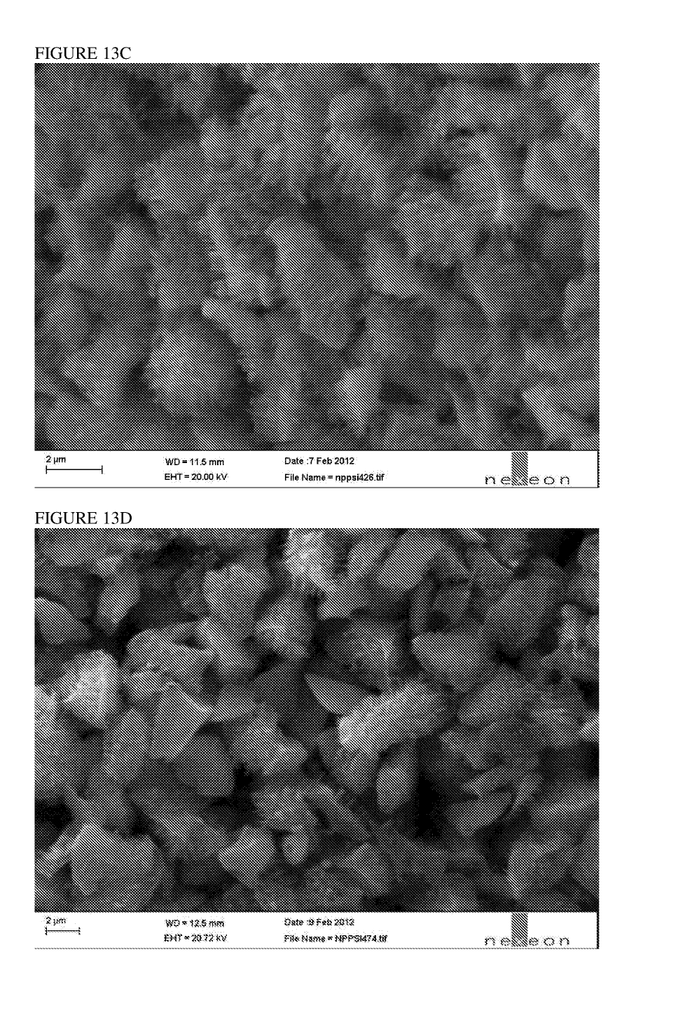

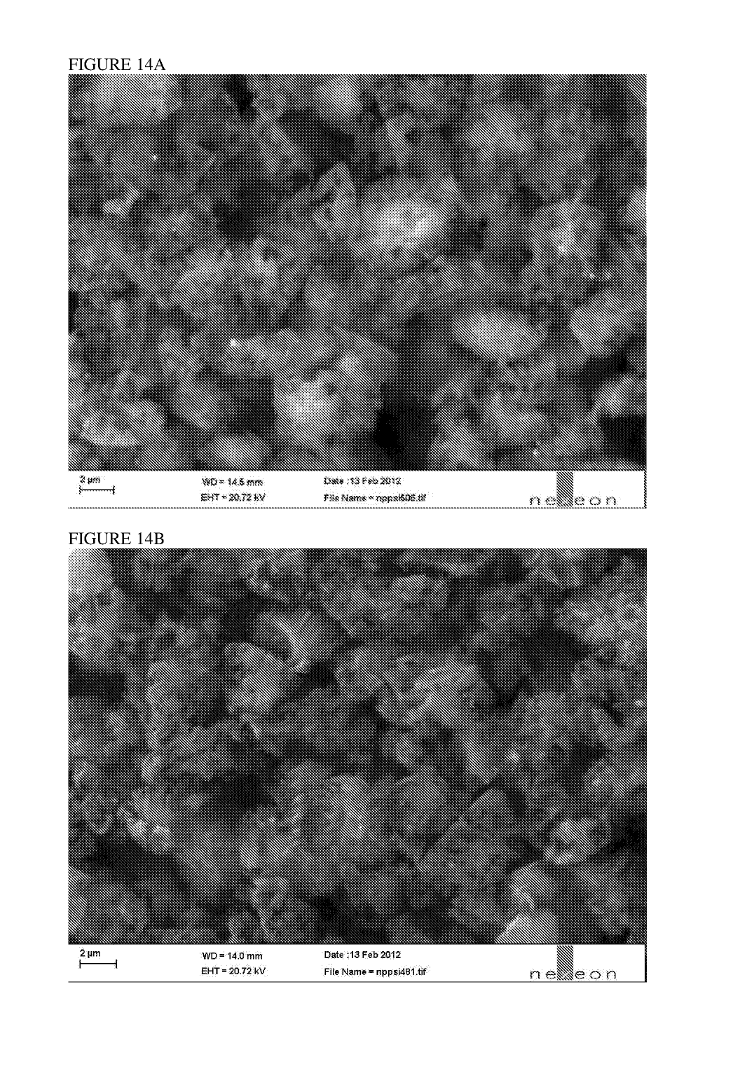

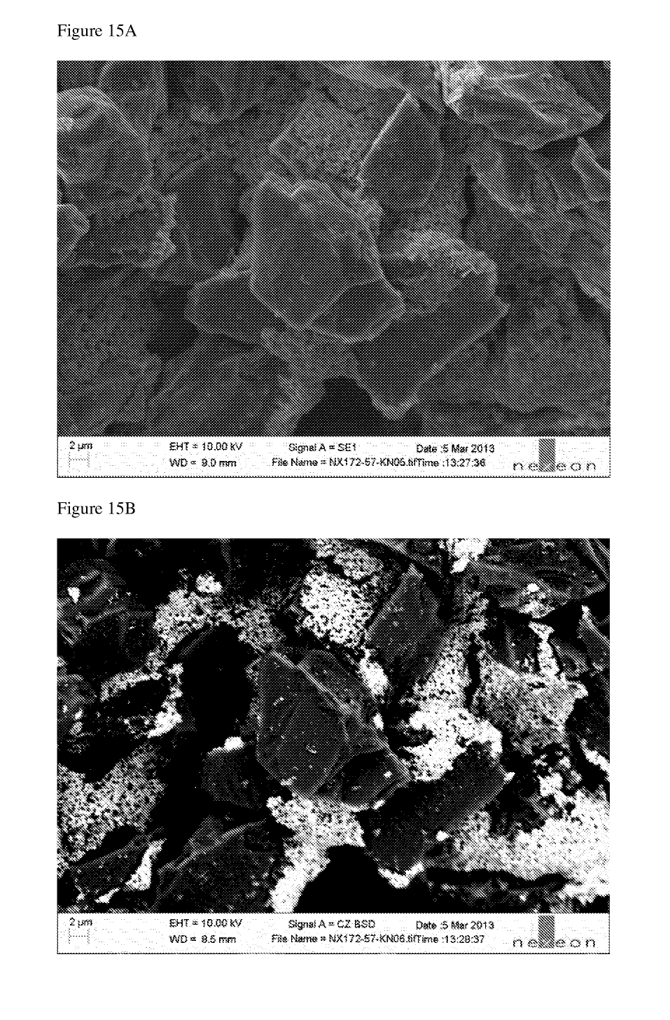

The images of FIGS. 15A and 15B show silver formed on the silicon surface using KOH, and prior to etching with HF. The surface includes regions of silver “mats” and regions of silver nanoparticles having a diameter of about 80±19 nm. In contrast, there is little or no silver nanoparticle formation when HF is used in silver deposition. The above method was also repeated with decreasing molar amounts of AgNO₃, down to 100 mL of 0.1M AgNO₃ solution, and the deposition of silver nanoparticles on the majority of silicon surfaces was still observed, demonstrating the efficacy of the method with lower amounts of silver ions.

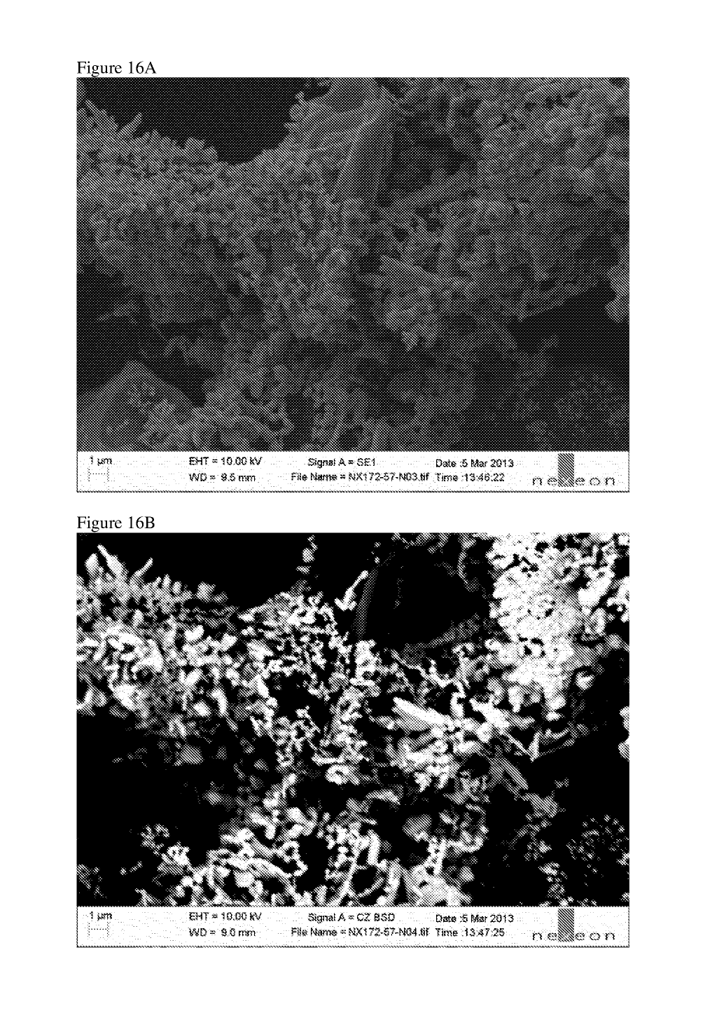

With reference to the images of FIGS. 16A and 16B, when the sample is initially placed into HF solution there is a change in the silver mat, which separates into smaller nucleates akin to aggregates of nanoparticles. There is also a colour change of the material at this point, indicating some plasmonic absorption from the silver, which only occurs over nanoscopic ranges.

The images of FIGS. 17A and 17B show pillars formed following completion of silicon etching by HF.

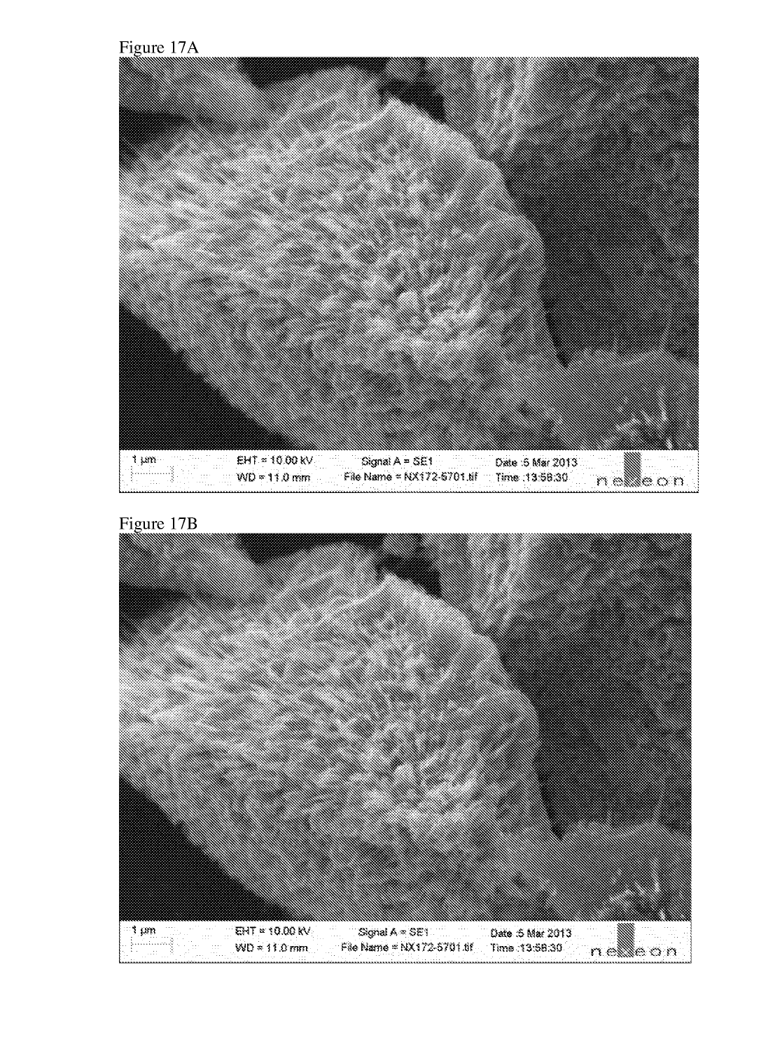

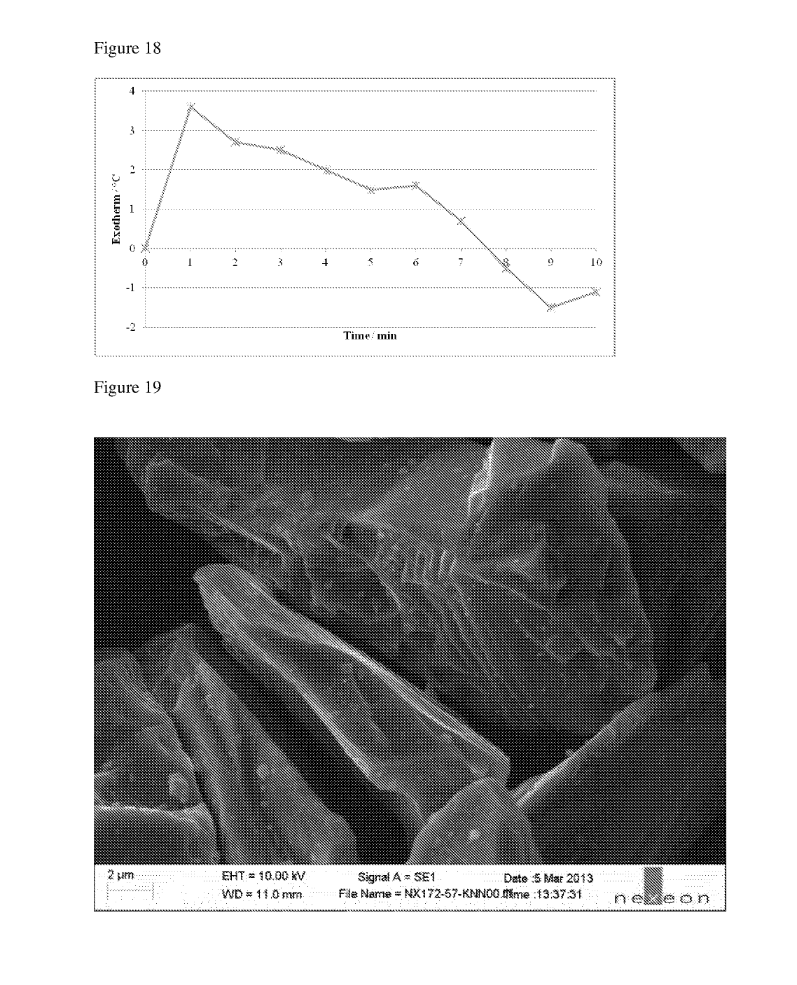

FIG. 18 is a graph of temperature over time, showing that temperature rises by less than 4° C. when using KOH to deposit silicon, whereas temperature rise using HF is much higher, and usually about 20-70° C. depending on the concentration of reagents and surface area of silicon. The less exothermic nature of the reaction may make it more controllable than reactions using HF, particularly for large scale treatment of silicon material.

The image of FIG. 19 shows silicon particles after deposition of silver using KOH as described above, followed by washing with nitric acid to remove the deposited silver. It can be seen that the surface of the silicon is smooth. In contrast, pitting of the silicon surface is observed when HF is used to deposit silver, which is believed to be a result of reaction of HF at the silicon surface, as shown in Equation 1 above.

### Comparative Example 17

Solutions of KOH and AgNO3 were mixed together. The mixed solution turned a yellow-black colour, indicating formation of Ag2O, which was not observed in Example 17 in which an alcohol was present.

### Example 18

1.5 g of silicon powder available from Elkem of Norway as Silgrain HQ jet-milled to a D₅₀ size of 23 microns, and having a BET value of 0.33 m²/g, and 1 g AgNO3 solid were placed in 200 g deionised water and stirred with a magnetic stirrer. The mixture was heated to boiling point.

25 ml of 2% Na3C6H5O7 (sodium citrate) solution was added to the boiling mixture. After 2.5 hours the particles were washed twice.

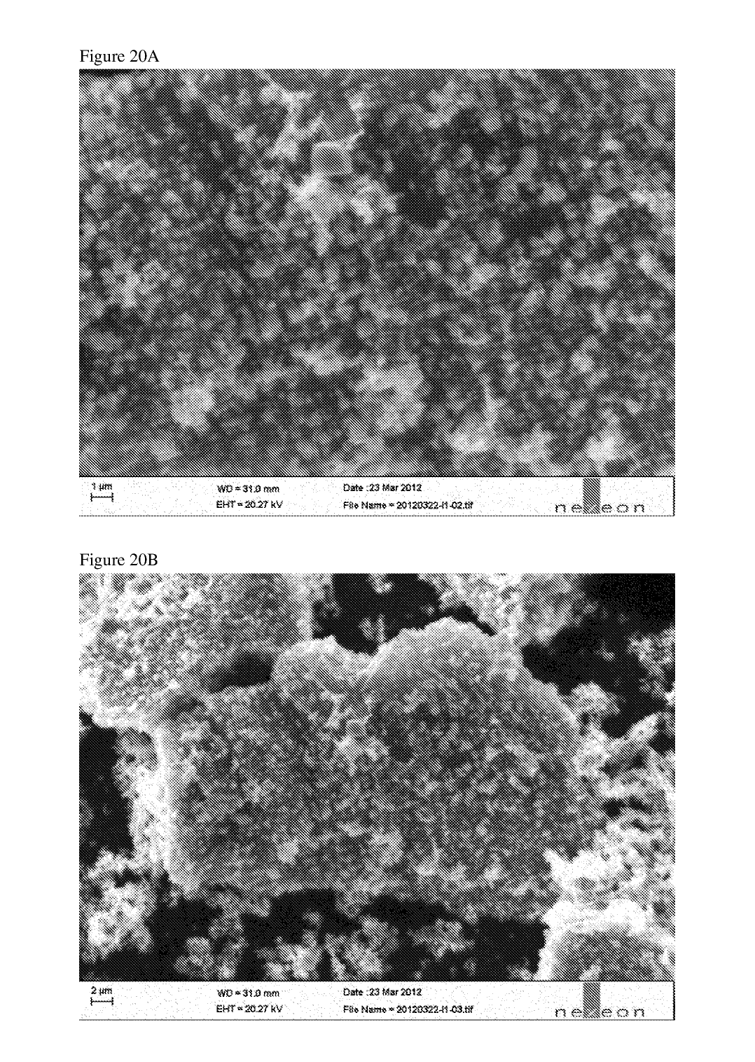

The SEM images of FIGS. 20A and 20B show formation of nanoparticles having a size in the range of 300-600 nm on the surface of the silicon particles.

To etch the surface of the silicon particles carrying silver nanoparticles, the washed particles were placed in 1 litre of a 7.5M HF solution, and 4 g 50% NH4NO3, and washed with nitric acid to remove silver.

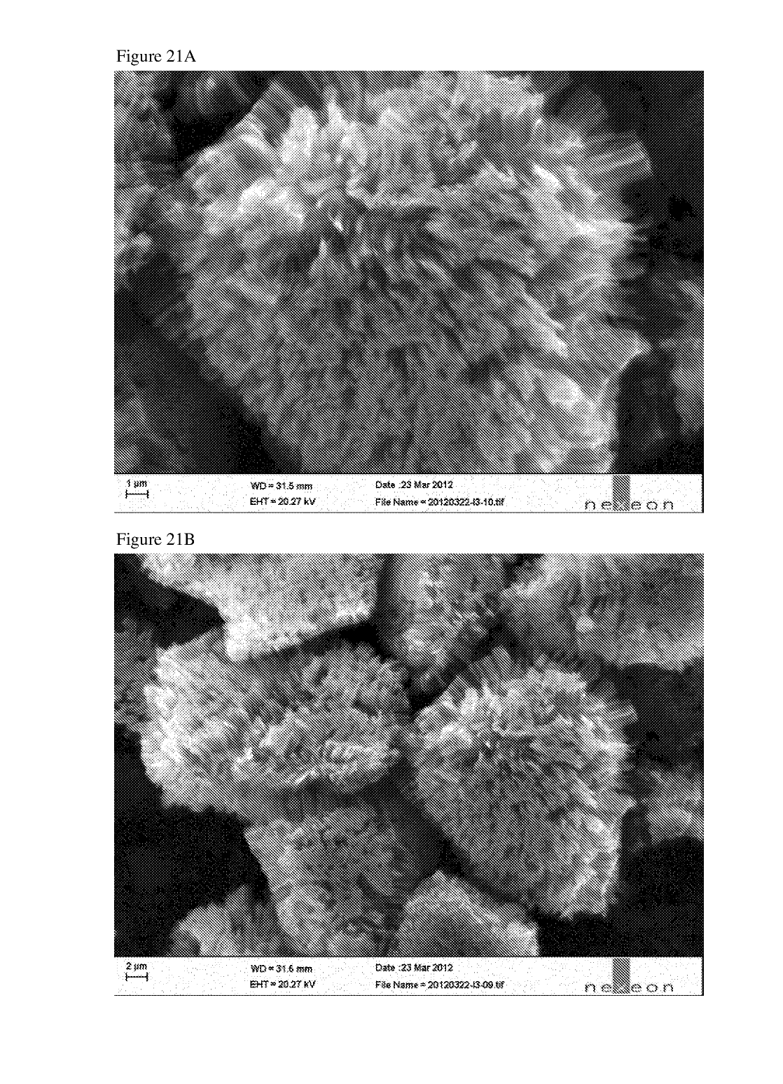

FIGS. 21A and 21B show pillars formed following etching.

### Example 19

A high purity silicon powder having the following properties was used for metal deposition and etching:

| | Silicon powder 3 |
|---|---|
| % Fe impurity | 0.015 |
| % Al impurity | 0.01 |
| Approximate | 99.88-99.96% |
| silicon purity | |
| D10 | 6.0 |
| D50 | 9.9 |
| D90 | 15.9 |
| BET (m2/g) | 0.98 |

Silver was deposited using: (A) HF only, (B) Tollen's reagent only, and (C) a two-stage process in which Tollen's reagent is used in a first deposition stage followed by washing in deionised water and a second deposition stage using HF. The amounts of the components used in each reaction are listed in the table below. As described above, during preparation of the Tollen's reagent, the ammonia is added dropwise in two separate steps. NH3 (I) indicates the total amount of ammonia added before KOH is added and NH3(II) indicates the amount of ammonia added after the KOH.

Silicon powders carrying silver deposited by (A), (B) and (C) were each etched using 7M HF and NHNO₃ in the ratios detailed below.

| | | | Ag+ | | | | | |
|---|---|---|---|---|---|---|---|---|
| | | | ions per | | | | | |
| | | Si:AgNO3 | m2 of | NH3 | | NH3 | Oxidant mass (ratio | |
| | | weight | Si | (I) | KOH | (II) | Si mass:NHNO3 | |
| Deposition process | Si | ratio | (mmol) | (g) | (g) | (g) | mass) | Yield |
| HF only (A) | 15 g | 1:0.75 | 4.5 | NA | NA | NA | 4.2 g × 4 (1:1.12) | 14% |
| | | (11.3 g) | | | | | | |
| Tollens reagent (B) | 15 g | 1:0.6 | 4 | 8.4 | 5.6 | 9.6 | 3.5 g × 6 (1:1.4) | 27% |
| | | (10 g) | | | | | | |
| Tollen's reagent + HF | 20 g | 1:0.55 | 3.3 | 5.4 | 5.6 | 4.8 | 3.5 g × 8 (1:1.4) | 28% |
| (C) | | (6 g + 5 g) | | | | | | |

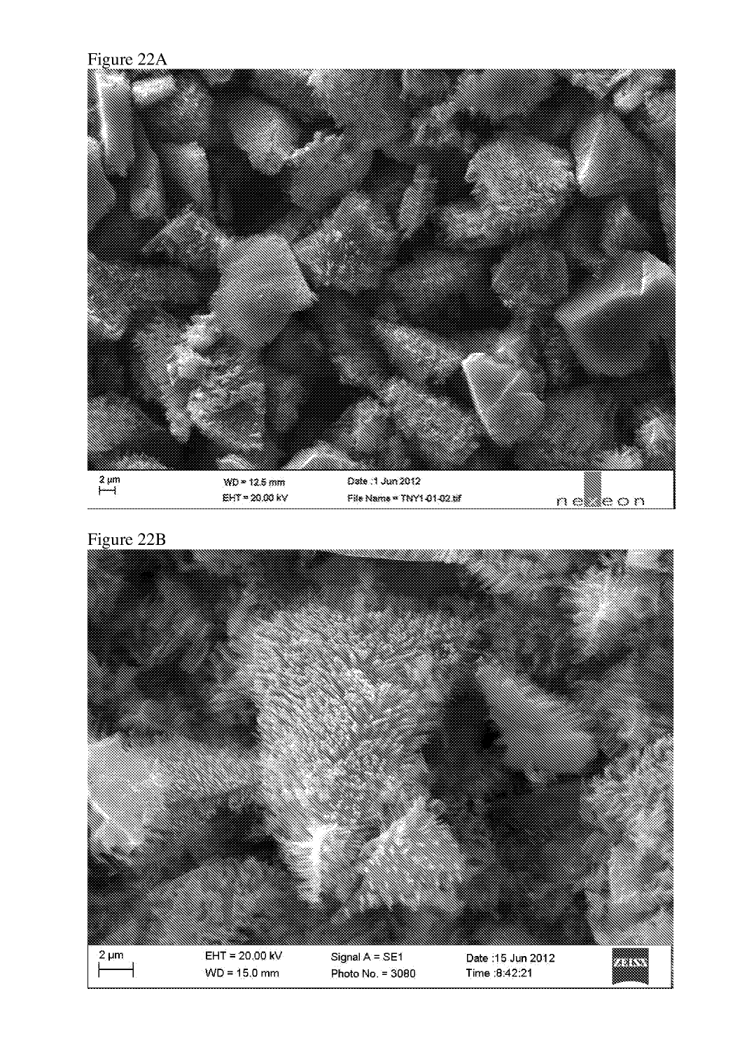

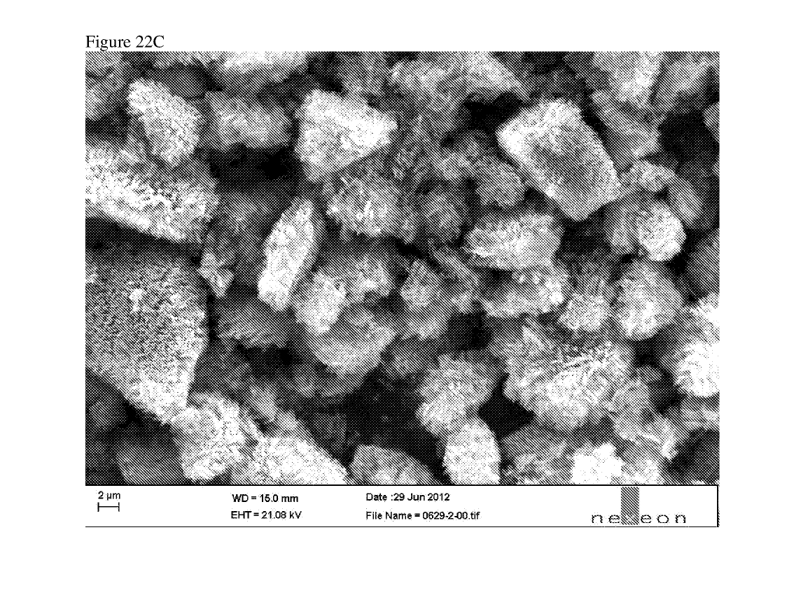

FIG. 22A is an SEM of the particles formed using HF alone (A).

In addition to the low yield of process (A) as shown in the table above, a large proportion of faces are unetched, and substantial fracturing is observed.

FIG. 22B is an SEM of the particles formed using Tollen's reagent (B).

In addition to the higher yield of process (B) as compared to process (A), as shown in the table above, more uniform etching of the silicon surfaces and better defined pillars is observed.

FIG. 22C is an SEM of the particles formed using Tollen's reagent and HF (C) showing a yet further improvement in uniformity as compared to process (B).

The yield of process (C) is similar to that of process (B), as shown in the table above.

Superior etching is observed using HF alone for metal deposition if the purity of the silicon is lower (for example, about 99.7-99.85%).

Without wishing to be bound by any theory, it is believed that metal impurities, for example iron or aluminium impurities, may facilitate metal deposition and etching. However, the present inventors have found that a process that entirely or partially avoids use of HF can provide good etching even at high purities.

The etched silicon as described herein may be used to form the anode of a rechargeable metal ion battery.

The invention has been described with reference to anodes of rechargeable batteries that operate by absorption and desorption of lithium ions, however it will be appreciated that etched silicon structures as described herein may be applicable to other metal ion batteries, for example sodium or magnesium ion batteries. Moreover, it will be appreciated that etched silicon as described herein may be used in devices other than metal ion batteries, for example filters, other energy storage devices such as fuel cells, photovoltaic devices such as solar cells, sensors, and capacitors. Etched silicon as described herein may also form conducting or semiconducting components of electronic circuitry.

Although the present invention has been described in terms of specific exemplary embodiments, it will be appreciated that various modifications, alterations and/or combinations of features disclosed herein will be apparent to those skilled in the art without departing from the scope of the invention as set forth in the following claims.

1. A method of etching silicon of a material comprising silicon, the method comprising the steps of partially covering a silicon surface of the material comprising silicon with an elemental metal and then carrying out a metal-assisted chemical etching of the silicon by exposing the partially covered silicon surface to an etching composition, wherein at least some of the elemental metal for the metal-assisted chemical etching is formed by
exposing the silicon surface to a composition comprising metal ions, wherein the elemental metal forms by reduction of the metal ions and wherein the composition comprising metal ions is substantially free of HG.

2. A method according to claim 1 wherein the composition comprising metal ions comprises:
(i) a reducing agent; or
(ii) an aldehyde reducing agent and an alkali; or
(iii) an aldehyde reducing agent and an alkali, wherein the alkali is a metal hydroxide or metal carbonate.

3-5. (canceled)

6. A method according to claim 1 wherein:
(i) the metal formed on the surface of the silicon is selected from silver, copper, platinum and gold; and/or
(ii) the etching composition is an aqueous etching composition comprising fluoride ions and an oxidant; and/or
(iii) the etching composition is an aqueous etching composition comprising fluoride ions and an oxidant, wherein the fluoride ions in the aqueous etching composition are provided by hydrogen fluoride; and/or
(iv) the etching composition is an aqueous etching composition comprising fluoride ions and an oxidant, wherein the oxidant is selected from the group consisting of O₂; O₃; hydrogen peroxide; and the acid or salt of NO₃⁻, S₂O₈²⁻, NO₂, B₄O₇²⁻ or ClO₄⁻ or a mixture thereof, and
wherein the oxidant is optionally selected from the group consisting of alkali metal nitrates, ammonium nitrate and mixtures thereof.

7-10. (canceled)

11. A method according to claim 1 wherein:
(i) the surface of the silicon is etched to a depth of at least 0.25 microns; and/or
(ii) the silicon to be etched is n-doped or a mixture thereof; and/or
(iii) the silicon to be etched comprises multiple faces and wherein the surface of more than one face is etched.

12. A method according to claim 1 wherein:
(i) the etched silicon comprises pores extending into the etched silicon surface, optionally wherein the pores have a diameter of at least 10 nm; or
(ii) the etched silicon comprises pillars extending out from an etched surface formed by etching the silicon surface, optionally wherein the pillars have a length of at least 0.5 microns.

13-16. (canceled)

17. A method according to claim 1 wherein:
(i) the silicon to be etched is in the form of bulk silicon, optionally a silicon wafer; or
(ii) the silicon to be etched is in the form of a silicon powder, optionally wherein at least 50% of the total volume of the powder is made up of starting material particles having a particle size of no more than 25 microns, and optionally wherein the powder has a surface area per unit weight of more than 1 m²/g.

18-21. (canceled)

22. A method according to claim 1 wherein:
(i) the material comprising silicon consists essentially of silicon having a purity of at least 90%; or
(ii) the material comprising silicon comprises a non-silicon core and a silicon shell.

23. (canceled)

24. A method according to claim 1 wherein at least some of the elemental metal for the metal-assisted chemical etching is formed by exposing the silicon surface to the composition comprising metal ions, wherein the composition comprising metal ions is substantially free of fluoride ions.

25. A method according to claim 1 wherein the step of partially covering a silicon surface of the material comprising silicon with an elemental metal comprises exposing the material comprising silicon to a plurality of compositions comprising metal ions, wherein the elemental metal forms on the silicon surface by reduction of the metal ions from each composition.

26. A method according to claim 9 wherein:
(i) at least one of the compositions comprising metal ions further comprises fluoride ions, optionally HF; or
(ii) substantially all of the elemental metal for the metal-assisted chemical etching is formed by exposing the silicon surface to a composition comprising metal ions, wherein the elemental metal forms by reduction of the metal ions and wherein the composition comprising metal ions is substantially free of HF.

27. (canceled)

28. A method according to claim 1 wherein:
(i) the metal ions are metal complex ions; and/or
(ii) the material comprising silicon is silicon having a purity of at least 99.8 weight %, optionally at least 99.85 weight %; and/or
(iii) the material comprising silicon contains less than 0.03 weight % iron, optionally less than 0.02 weight % iron; and/or
(iv) the material comprising silicon contains less than 0.08 weight %, aluminum, optionally less than 0.05 weight %, or less than 0.02 weight % aluminum.

29-31. (canceled)

32. Etched silicon obtainable by a method according to claim 1.

33. An electrode comprising an active material of etched silicon according to claim 32, optionally wherein the electrode further comprises a conductive current collector in electrical contact with the active material.

34. (canceled)

35. A method of forming an electrode comprising an active material of etched silicon and a conductive current collector in electrical contact with the active material, the method comprising the step of depositing onto the conductive current collector a slurry comprising an etched silicon powder according to claim 32 and at least one solvent, and evaporating the at least one solvent.

36. A rechargeable metal ion battery comprising an anode, the anode comprising an electrode according to claim 33 capable of inserting and releasing metal ions; a cathode formed from a metal-containing compound capable of releasing and reabsorbing the metal ions; and an electrolyte between the anode and the cathode, optionally wherein the metal ion battery is a lithium ion battery.

37. (canceled)

38. A method of etching silicon of a material comprising silicon, the method comprising the steps of:
electrolessly depositing a first metal onto silicon at a surface of the material comprising silicon, wherein the electrolessly deposited first metal partially covers the silicon surface and wherein the first metal is deposited from a composition comprising ions of the metal, the composition being substantially free of HF, optionally substantially free of fluoride ions;
depositing a second metal over the silicon surface and the electrolessly deposited first metal, wherein a film of the deposited second metal covers substantially all of the surface of the silicon surface;
removing the first metal, and the second metal from regions of the film of the deposited second metal that overlie the first metal to leave the second metal partially covering the surface of the silicon to be etched; and
etching the silicon by exposing the silicon surface to an etching composition.

39. A method of etching silicon of a material comprising silicon, the method comprising the steps of partially covering a silicon surface of the material comprising silicon with an elemental metal and then carrying out a metal-assisted chemical etching of the silicon by exposing the partially covered silicon surface to an etching composition, wherein at least some of the elemental metal for the metal-assisted chemical etching is formed by exposing the silicon surface to a composition comprising metal ions, wherein the elemental metal forms by reduction of the metal ions and wherein the composition comprising metal ions comprises:
(i) an aldehyde reducing agent and an alkali; or
(ii) a metal citrate, a metal borohydride, a hydrazine or a metal hypophosphite; or
(iii) an alcohol and a metal hydroxide, such as an alkali hydroxide.

40-42. (canceled)

43. A method according to claim 9, wherein the elemental metal is formed by exposing the silicon surface to a first composition comprising metal ions to form a first portion of the elemental metal on the silicon surface by reduction of the metal ions of the first composition; removing the material from the first composition; and exposing the silicon surface to a second composition comprising metal ions to form a second portion of the elemental metal on the silicon surface by reduction of the metal ions of the second composition, wherein the second composition is different from the first composition.

44. A method according to claim 43 wherein:
(i) at least one of the first and second compositions comprises a reducing agent; or
(ii) both of the first and second compositions comprise a reducing agent; or
(iii) the first and second compositions comprise the same reducing agent; or
(iv) the first and second compositions comprise different reducing agents.

45-47. (canceled)

48. A method according to claim 44 wherein the reducing agent of the first and/or second composition is independently selected from the group consisting of alcohols, aldehydes, metal borohydrides, hydrazines, acids, metal hydroxides, metal citrates and metal hypophosphite, and optionally the reducing agent of one of the first or second compositions is HF.

49. (canceled)
